(19) United States
(12) Patent Application Publication
(10) Pub. No.: US 2016/0279932 A1
(43) Pub. Date: Sep. 29, 2016

(54) LIQUID DISCHARGING APPARATUS, HEAD UNIT, CONTROL METHOD FOR LIQUID DISCHARGING APPARATUS, AND CONTROL PROGRAM FOR LIQUID DISCHARGING APPARATUS

(71) Applicant: Seiko Epson Corporation, Tokyo (JP)

(72) Inventor: Masashi KAMIYANAGI, Matsumoto (JP)

(21) Appl. No.: 15/059,598

(22) Filed: Mar. 3, 2016

(30) Foreign Application Priority Data
Mar. 25, 2015 (JP) 2015-061842

(51) Int. Cl. B41J 2/045

(52) U.S. Cl. CPC B41J 2/04588; B41J 2/04581

(57) ABSTRACT

Provided is a liquid discharging apparatus including a waveform signal generator that generates a drive waveform signal which includes a plurality of waveforms including an inspection waveform; a first discharger including a first piezoelectric element that is displaced by being supplied with a first drive signal; a first switch that is capable of switching whether to supply the first drive signal to the first piezoelectric element for each unit period; and a detector that detects residual vibration occurring in the first discharger after the first drive signal including the inspection waveform is supplied to the first piezoelectric element, in which the first switch stops supply of the first drive signal to the first piezoelectric element during a unit period that precedes one unit period when the first drive signal including the inspection waveform is supplied to the first piezoelectric element during the one unit period.

### CROSS REFERENCE TO RELATED APPLICATIONS

This application claims priority to Japanese Patent Application No. 2015-061842 filed on Mar. 25, 2015. The entire disclosure of Japanese Patent Application No. 2015-061842 is hereby incorporated herein by reference.

### BACKGROUND

1. Technical Field

The present invention relates to a liquid discharging apparatus, a head unit, a control method for a liquid discharging apparatus, and a control program for a liquid discharging apparatus.

2. Related Art

A liquid discharging apparatus such as an ink jet printer forms an image on a recording medium by driving a discharger disposed in a head unit with a drive signal to discharge liquid such as ink filling a cavity (pressure chamber) of the discharger. In such a liquid discharging apparatus, there may occur an abnormal discharge that is a situation where liquid cannot be normally discharged from the discharger because of thickening of liquid, mingling of an air bubble with liquid in the cavity, or the like. If an abnormal discharge occurs, a dot that is supposed to be formed on the medium by the liquid discharged from the discharger cannot be accurately formed, and the quality of the image formed by the liquid discharging apparatus decreases.

In JP-A-2004-276544, there is suggested a technology that prevents a decrease in image quality due to an abnormal discharge by determining the state of liquid discharged in the discharger on the basis of residual vibration occurring in the discharger after driving of the discharger to detect an abnormal discharge.

The state of liquid discharged in the discharger is generally determined on the basis of the waveform of residual vibration that occurs in the discharger after the discharger is driven by a drive signal having an inspection waveform (referred to as “inspection drive signal”). Thus, in order to determine the state of discharge accurately, it is preferable to detect only the vibration of the discharger occurring from the inspection drive signal as residual vibration. That is, in order to determine the state of discharge accurately, it is required to supply the inspection drive signal to the discharger in a state where the discharger does not vibrate.

However, the recent speed-up in printing results in an increasing drive frequency, and the interval between driving of the discharger and subsequent driving thereof may be shortened. In addition, in order to prevent an abnormal discharge caused by thickening of liquid in the cavity, it may be required that driving of the discharger produces periodic micro vibration to stir the liquid in the cavity periodically. In such a situation where the discharger is periodically driven at a short interval, the discharger may be driven by the inspection drive signal even though the vibration based on the previous driving is not sufficiently attenuated. In this case, it is difficult to detect only the vibration of the discharger occurring from the inspection drive signal, thereby posing a problem in that the state of discharge in the discharger cannot be accurately determined.

### SUMMARY

An advantage of some aspects of the invention is to provide a technology that enables increasing the accuracy of determining the state of liquid discharged from a discharger.

According to an aspect of the invention, there is provided a liquid discharging apparatus including a waveform signal generator that generates a drive waveform signal which includes a plurality of waveforms including an inspection waveform; a first discharger including a first piezoelectric element that is displaced by being supplied with a first drive signal which includes a waveform selected from the plurality of waveforms included in the drive waveform signal, a first pressure chamber that has internal pressure increased or decreased by the displacement of the first piezoelectric element, and a first nozzle that communicates with the first pressure chamber and is capable of discharging liquid filling the first pressure chamber in response to an increase or a decrease in the internal pressure of the first pressure chamber; a first switch that is capable of switching whether to supply the first drive signal to the first piezoelectric element for each unit period; and a detector that detects residual vibration occurring in the first discharger after the first drive signal including the inspection waveform is supplied to the first piezoelectric element, in which the first switch stops supply of the first drive signal to the first piezoelectric element during a unit period that precedes one unit period when the first drive signal including the inspection waveform is supplied to the first piezoelectric element during the one unit period.

According to another aspect of the invention, there is provided a head unit that is supplied with a drive waveform signal which includes a plurality of waveforms including an inspection waveform, the unit including a first discharger including a first piezoelectric element that is displaced by being supplied with a first drive signal which includes a waveform selected from the plurality of waveforms included in the drive waveform signal, a first pressure chamber that has internal pressure increased or decreased by the displacement of the first piezoelectric element, and a first nozzle that communicates with the first pressure chamber and is capable of discharging liquid filling the first pressure chamber in response to an increase or a decrease in the internal pressure of the first pressure chamber; a first switch that is capable of switching whether to supply the first drive signal to the first piezoelectric element for each unit period; and a detector that detects residual vibration occurring in the first discharger after the first drive signal including the inspection waveform is supplied to the first piezoelectric element, in which the first switch stops supply of the first drive signal to the first piezoelectric element during a unit period that precedes one unit period when the first drive signal including the inspection waveform is supplied to the first piezoelectric element during the one unit period.

According to these aspects of the invention, supply of the first drive signal to the first discharger is stopped during a unit period preceding the one unit period (hereinafter, referred to as “preceding unit period”). Thus, the magnitude of vibration that occurs in the first discharger at the timing of the start of the one unit period can be reduced to a smaller extent in comparison with a case where the first discharger is driven during the preceding unit period. In other words, it is possible to prevent vibration of the first discharger occurring in the preceding unit period from being superimposed on residual vibration of the first discharger that is caused by the first drive signal including the inspection waveform. Accordingly, residual vibration of the first discharger that is caused by the first drive signal including the inspection waveform can be accurately detected in comparison with a case where the first discharger is driven during the preceding unit period, and the state of the liquid discharged in the first discharger can be accurately determined.

According to still another aspect of the invention, a liquid discharging apparatus may include a first discharger including a first piezoelectric element that is displaced in response to a first drive signal, a first pressure chamber that has internal pressure increased or decreased by the displacement of the first piezoelectric element, and a first nozzle that communicates with the first pressure chamber and is capable of discharging liquid filling the first pressure chamber in response to an increase or a decrease in the internal pressure of the first pressure chamber; a supplier that generates the first drive signal on the basis of a drive waveform signal which includes a plurality of waveforms including an inspection waveform and that supplies the generated first drive signal to the first piezoelectric element for each unit period; and a detector that detects residual vibration occurring in the first discharger after the supplier supplies the first drive signal including the inspection waveform to the first piezoelectric element, in which the supplier fixes the potential of the first drive signal supplied to the first piezoelectric element to a predetermined reference potential during a unit period that precedes one unit period when supplying the first drive signal including the inspection waveform to the first piezoelectric element during the one unit period.

The liquid discharging apparatus may further include a second discharger including a second piezoelectric element that is displaced by being supplied with a second drive signal which includes a waveform selected from the plurality of waveforms included in the drive waveform signal, a second pressure chamber that is adjacent to the first pressure chamber through a partition and has internal pressure increased or decreased by the displacement of the second piezoelectric element, and a second nozzle that communicates with the second pressure chamber and is capable of discharging liquid filling the second pressure chamber in response to an increase or a decrease in the internal pressure of the second pressure chamber; and a second switch that is capable of switching whether to supply the second drive signal to the second piezoelectric element for each unit period, in which the second switch stops supply of the second drive signal to the second piezoelectric element during the one unit period.

In this case, supply of the second drive signal to the second discharger adjacent to the first discharger is stopped during the one unit period. Thus, vibration that propagates from the second discharger to the first discharger can be reduced in comparison with a case where the second discharger is driven during the one unit period. In other words, it is possible to prevent vibration propagating from the second discharger from being superimposed on residual vibration of the first discharger that is caused by the first drive signal including the inspection waveform. Accordingly, residual vibration of the first discharger that is caused by the first drive signal including the inspection waveform can be accurately detected in comparison with a case where the second discharger is driven during the one unit period, and the state of the liquid discharged in the first discharger can be accurately determined.

In the liquid discharging apparatus, the second switch may supply the second drive signal including the inspection waveform to the second piezoelectric element during a unit period subsequent to the one unit period, and the detector may detect residual vibration that occurs in the second discharger after the second drive signal including the inspection waveform is supplied to the second piezoelectric element.

In this case, the second drive signal is supplied to the second discharger during a unit period subsequent to the one unit period (hereinafter, referred to as “subsequent unit period”) after driving of the second discharger is stopped in the one unit period. Thus, the magnitude of vibration that occurs in the second discharger at the timing of the start of the subsequent unit period can be reduced to a smaller extent in comparison with a case where the second discharger is driven during the one unit period. In other words, it is possible to prevent vibration of the second discharger occurring in the one unit period from being superimposed on residual vibration of the second discharger that is caused by the second drive signal including the inspection waveform. Accordingly, residual vibration of the second discharger that is caused by the second drive signal including the inspection waveform can be accurately detected in comparison with a case where the second discharger is driven during the one unit period, and the state of the liquid discharged in the second discharger can be accurately determined.

In the liquid discharging apparatus, the plurality of waveforms included in the drive waveform signal may include a micro vibration waveform that displaces the first piezoelectric element such that the liquid is not discharged from the first nozzle when the drive waveform signal is supplied to the first piezoelectric element, and the micro vibration waveform may be started after the end of the inspection waveform in the unit period.

In this case, the inspection waveform is arranged before the start of the micro vibration waveform in each unit period. Thus, even if a discharger different from the first discharger is driven by a drive signal including the micro vibration waveform during one unit period, residual vibration of the first discharger can be detected at a timing before vibration propagates from the discharger to the first discharger. Accordingly, residual vibration of the discharger that is caused by the drive signal including the inspection waveform can be accurately detected in comparison with a case where the inspection waveform is arranged after the start of the micro vibration waveform, and the state of the liquid discharged in the discharger can be accurately determined.

In addition, in this case, since the period from the start of the unit period until the start of the inspection waveform is short, error between a designed timing at which the inspection waveform is to be supplied to the discharger and the actual timing at which the inspection waveform is supplied to the discharger can be reduced to a smaller extent in comparison with a case where the period from the start of the unit period until the start of the inspection waveform is long. Thus, the state of the liquid discharged in the discharger can be accurately determined.

In the liquid discharging apparatus, the plurality of waveforms included in the drive waveform signal may include a micro vibration waveform that displaces the first piezoelectric element such that the liquid is not discharged from the first nozzle when the drive waveform signal is supplied to the first piezoelectric element, and the first switch may supply the first drive signal including the micro vibration waveform to the first piezoelectric element during a unit period subsequent to the one unit period.

In the liquid discharging apparatus, the first switch may switch whether to supply the first drive signal to the first piezoelectric element for each unit period on the basis of a specification signal that specifies a waveform to be supplied to the first piezoelectric element for each unit period from the plurality of waveforms included in the drive waveform signal.

In this case, the specification signal can specify whether to supply the drive signal to each discharger during each unit period and the waveform of the drive signal in a case of supplying the drive signal. Thus, the state of the liquid discharged in the first discharger can be accurately determined by specifying stopping the supply of the first drive signal to the first discharger during the preceding unit period and specifying supply of the first drive signal including the inspection waveform to the first discharger during the one unit period with the specification signal.

The first switch may not supply the first drive signal to the first discharger when the specification signal does not specify a waveform to be supplied to the first discharger.

According to still another aspect of the invention, there is provided a control method for a liquid discharging apparatus including a waveform signal generator that generates a drive waveform signal which includes a plurality of waveforms including an inspection waveform; a first discharger including a first piezoelectric element that is displaced by being supplied with a first drive signal which includes a waveform selected from the plurality of waveforms included in the drive waveform signal, a first pressure chamber that has internal pressure increased or decreased by the displacement of the first piezoelectric element, and a first nozzle that communicates with the first pressure chamber and is capable of discharging liquid filling the first pressure chamber in response to an increase or a decrease in the internal pressure of the first pressure chamber; a first switch that is capable of switching whether to supply the first drive signal to the first piezoelectric element for each unit period; and a detector that detects residual vibration occurring in the first discharger after the first drive signal including the inspection waveform is supplied to the first piezoelectric element, the method including controlling operation of the first switch to stop supply of the first drive signal to the first piezoelectric element during a unit period that precedes one unit period when the first drive signal including the inspection waveform is supplied to the first piezoelectric element during the one unit period.

According to this aspect of the invention, supply of the first drive signal to the first discharger is stopped during the preceding unit period. Thus, the magnitude of vibration that occurs in the first discharger at the timing of the start of the one unit period can be reduced to a smaller extent in comparison with a case where the first discharger is driven during the preceding unit period. Thus, residual vibration of the first discharger that is caused by the first drive signal including the inspection waveform can be accurately detected, and the state of the liquid discharged in the first discharger can be accurately determined.

According to still another aspect of the invention, there is provided a control program for a liquid discharging apparatus including a waveform signal generator that generates a drive waveform signal which includes a plurality of waveforms including an inspection waveform; a first discharger including a first piezoelectric element that is displaced by being supplied with a first drive signal which includes a waveform selected from the plurality of waveforms included in the drive waveform signal, a first pressure chamber that has internal pressure increased or decreased by the displacement of the first piezoelectric element, and a first nozzle that communicates with the first pressure chamber and is capable of discharging liquid filling the first pressure chamber in response to an increase or a decrease in the internal pressure of the first pressure chamber; a first switch that is capable of switching whether to supply the first drive signal to the first piezoelectric element for each unit period; a detector that detects residual vibration occurring in the first discharger after the first drive signal including the inspection waveform is supplied to the first piezoelectric element; and a computer, the program causing the computer to function as a controller that controls operation of the first switch to stop supply of the first drive signal to the first piezoelectric element during a unit period that precedes one unit period when the first drive signal including the inspection waveform is supplied to the first piezoelectric element during the one unit period.

According to this aspect of the invention, supply of the first drive signal to the first discharger is stopped during the preceding unit period. Thus, the magnitude of vibration that occurs in the first discharger at the timing of the start of the one unit period can be reduced to a smaller extent in comparison with a case where the first discharger is driven during the preceding unit period. Thus, residual vibration of the first discharger that is caused by the first drive signal including the inspection waveform can be accurately detected, and the state of the liquid discharged in the first discharger can be accurately determined.

### BRIEF DESCRIPTION OF THE DRAWINGS

The invention will be described with reference to the accompanying drawings, wherein like numbers reference like elements.

FIG. 1 is a block diagram illustrating a configuration of a printing system according to an embodiment of the invention.

FIG. 2 is a schematic partial sectional view of an ink jet printer.

FIG. 3 is a schematic sectional view of a recording head.

FIG. 4 is a plan view illustrating an example of a nozzle arrangement in the recording head.

FIGS. 5A to 5C are descriptive diagrams illustrating a change in the sectional shape of a discharger at the time of supply of a drive signal.

FIG. 6 is a circuit diagram illustrating a simple harmonic vibration model representing residual vibration in the discharger.

FIG. 7 is a graph illustrating a relationship between the experimental value and a calculated value of residual vibration in the discharger.

FIG. 8 is a descriptive diagram illustrating a state of the discharger when an air bubble mingles in the discharger.

FIG. 9 is a graph illustrating an experimental value and a calculated value of residual vibration in the discharger.

FIG. 10 is a descriptive diagram illustrating a state of the discharger when ink solidifies near a nozzle.

FIG. 11 is a graph illustrating an experimental value and a calculated value of residual vibration in the discharger.

FIG. 12 is a descriptive diagram illustrating a state of the discharger when paper dust is attached thereto.

FIG. 13 is a graph illustrating an experimental value and a calculated value of residual vibration in the discharger.

FIG. 14 is a block diagram illustrating a configuration of a drive signal generator.

FIGS. 15A and 15B are descriptive diagrams illustrating the content of decoding performed by a decoder.

FIG. 16 is a timing chart illustrating operation of the drive signal generator.

FIG. 17 is a timing chart illustrating operation of the drive signal generator.

FIG. 18 is a timing chart illustrating the waveform of the drive signal.

FIG. 19 is a descriptive diagram illustrating a connection relationship between a connector and a residual vibration detector.

FIG. 20 is a timing chart illustrating the waveform of the drive signal.

FIG. 21 is a timing chart illustrating operation of a measurer.

FIG. 22 is a descriptive diagram illustrating determination information.

### DESCRIPTION OF EXEMPLARY EMBODIMENTS

Hereinafter, an embodiment of the invention will be described with reference to the drawings. It is to be noted that dimensions and the scale of each unit in each drawing are made appropriately different from reality. In addition, while a variety of technically preferred limitations are placed on the embodiment that is described below as a specific exemplary example of the invention, the scope of the invention is not limited to the embodiment unless limitation of the invention is intended in particular in the description below.

### A. Embodiment

A liquid discharging apparatus will be described in the present embodiment as an ink jet printer that forms an image on a recording paper P (an example of “medium”) by discharging ink (an example of “liquid”).

### 1. Summary of Printing System

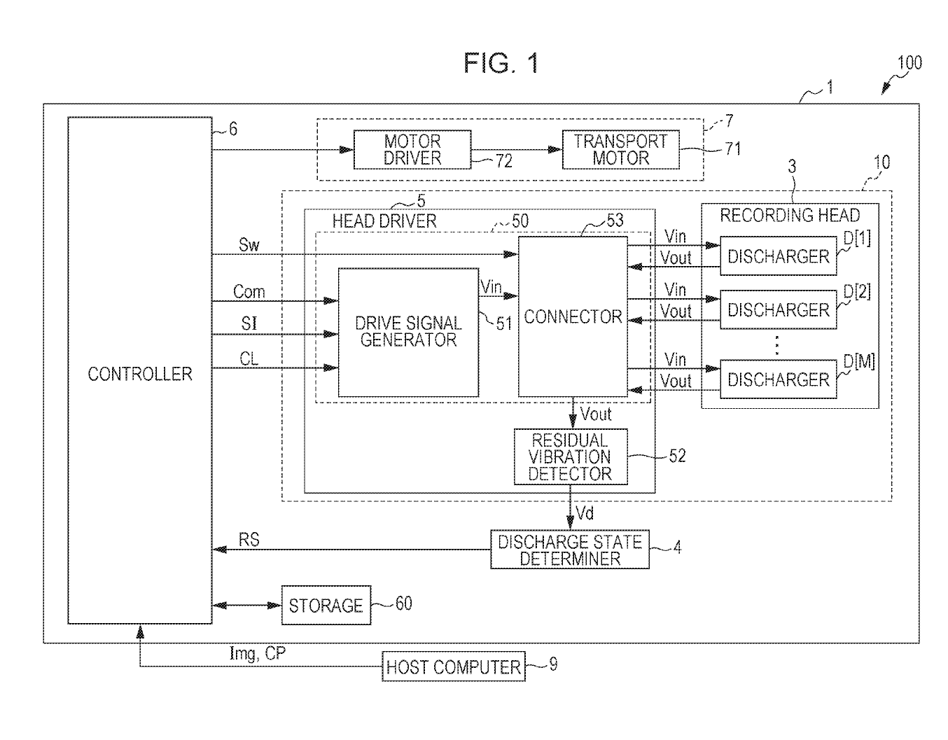

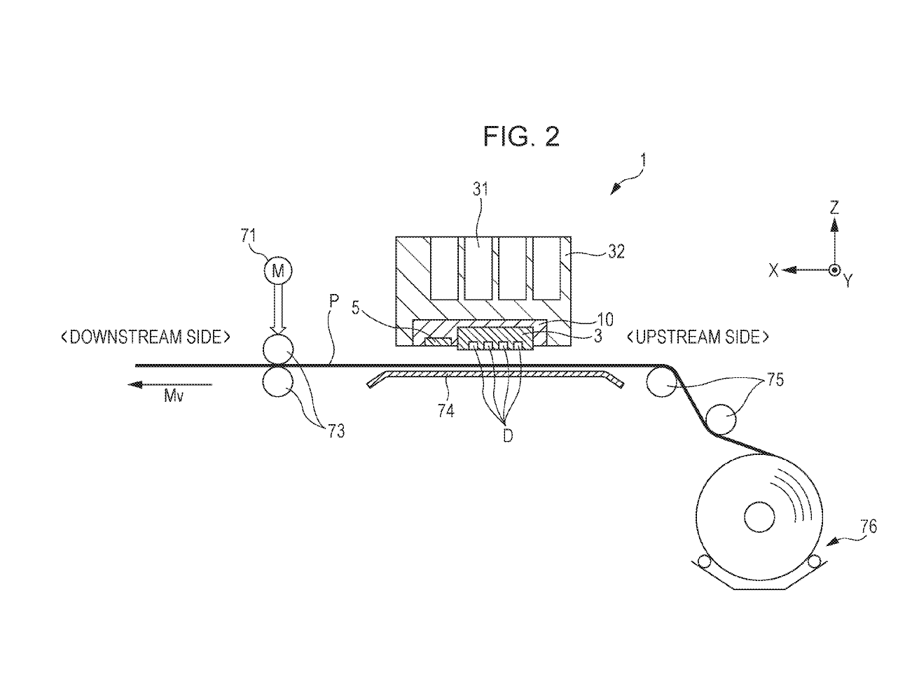

A configuration of an ink jet printer 1 according to the present embodiment will be described with reference to FIG. 1 and FIG. 2.

FIG. 1 is a functional block diagram illustrating a configuration of a printing system 100 that includes the ink jet printer 1. The printing system 100 includes the ink jet printer 1 and a host computer 9 such as a personal computer or a digital camera.

The host computer 9 outputs print data Img and copy number information CP. The print data Img represents an image to be formed by the ink jet printer 1, and the copy number information CP indicates a printed copy number Wcp that is the number of printed copies of the image to be formed by the ink jet printer 1. The ink jet printer 1 performs a printing process of forming the image represented by the print data Img supplied from the host computer 9 on the recording paper P in quantities of the printed copy number Wcp indicated by the copy number information CP. The ink jet printer 1 will be described as a line printer in the present embodiment.

As illustrated in FIG. 1, the ink jet printer 1 includes a head unit 10, a discharge state determiner 4, a transport mechanism 7, a controller 6, a storage 60, a recovery mechanism (not illustrated), and a display operating unit (not illustrated). The head unit 10 includes a discharger D that discharges ink. The discharge state determiner 4 determines the state of ink discharged from the discharger D. The transport mechanism 7 changes the position of the recording paper P relative to the head unit 10. The controller 6 controls operation of each unit of the ink jet printer 1. The storage 60 stores a control program for the ink jet printer 1 and other information. The recovery mechanism performs a maintenance process of recovering the state of ink discharged in the discharger D when an abnormal discharge occurring in the discharger D is detected. The display operating unit includes a display and an operating unit. The display is configured of a liquid crystal display or an LED lamp and displays an error message and the like, and the operating unit is used by a user of the ink jet printer 1 for inputting various commands and the like into the ink jet printer 1.

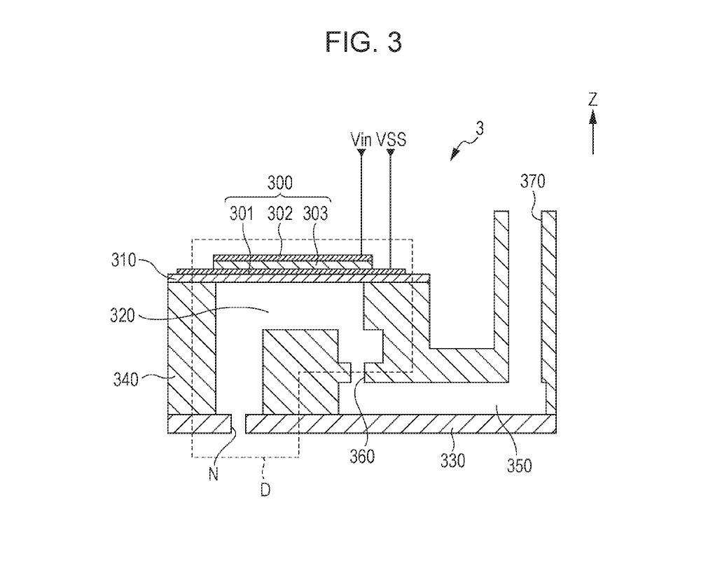

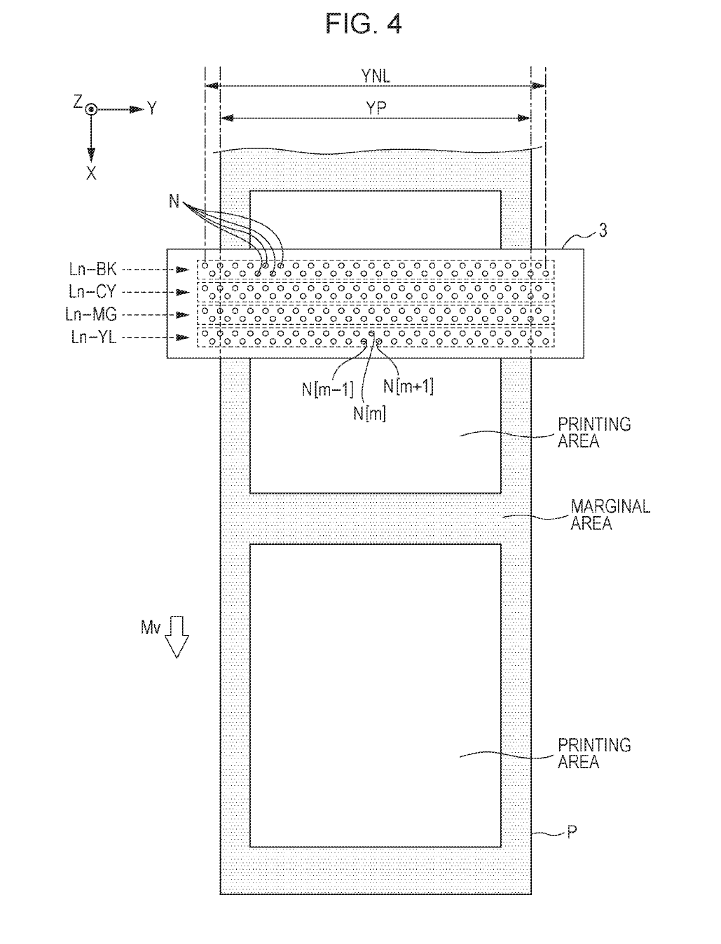

An abnormal discharge means that the state of ink discharged in the discharger D is abnormal. In other words, states where ink cannot be accurately discharged from a nozzle N (refer to FIG. 3 and FIG. 4 described later) included in the discharger D are collectively referred to as an abnormal discharge. More specifically, an abnormal discharge includes a state where the discharger D cannot discharge ink; a state where, even if ink can be discharged from the discharger D, the discharger D cannot discharge a necessary amount of ink for forming the image represented by the print data Img because the amount of ink discharged is small; a state where the amount of ink discharged from the discharger D is greater than the necessary amount for forming the image represented by the print data Img; a state where ink discharged from the discharger D hits a position different from the position where the ink is supposed to hit in order to form the image represented by the print data Img; and the like.

FIG. 2 is a partial sectional view schematically illustrating an internal configuration of the ink jet printer 1.

As illustrated in FIG. 2, the ink jet printer 1 includes a carriage 32 on which the head unit 10 is mounted. Four ink cartridges 31 are mounted on the carriage 32 in addition to the head unit 10. The four ink cartridges 31 are disposed in one-to-one correspondence with four colors (CMYK) of black (BK), cyan (CY), magenta (MG), and yellow (YL), and each ink cartridge 31 is filled with a color ink that corresponds to each ink cartridge 31. Each ink cartridge 31 may be disposed at a different place in the ink jet printer 1 instead of being mounted on the carriage 32.

As illustrated in FIG. 1, the transport mechanism 7 includes a transport motor 71 and a motor driver 72. The transport motor 71 is a drive source for transporting the recording paper P, and the motor driver 72 drives the transport motor 71.

In addition, the transport mechanism 7, as illustrated in FIG. 2, includes a platen 74, a transport roller 73, a guide roller 75, and an accommodator 76. The platen 74 is disposed under the carriage 32 (in the −Z direction of FIG. 2). The transport roller 73 is rotated by operation of the transport motor 71. The guide roller 75 is disposed to rotate around the Y axis of FIG. 2. The accommodator 76 accommodates the recording paper P that is wound into a roll.

The transport mechanism 7, when the ink jet printer 1 performs the printing process, unwinds the recording paper P from the accommodator 76 and transports the recording paper P at a transport speed My in the +X direction of FIG. 2 (direction toward a downstream side from an upstream side) along a transport path that is defined by the guide roller 75, the platen 74, and the transport roller 73.

The storage 60 includes an electrically erasable programmable read-only memory (EEPROM) that is one type of non-volatile semiconductor memory storing the print data Img supplied from the host computer 9, a random access memory (RAM) that temporarily stores necessary data when various processes such as the printing process is performed or that is used for temporarily loading a control program which performs various processes such as the printing process, and a PROM that is one type of non-volatile semiconductor memory storing a control program which controls each unit of the ink jet printer 1.

The controller 6 is configured to include a central processing unit (CPU), a field-programmable gate array (FPGA), or the like and controls operation of each unit of the ink jet printer 1 with the CPU or the like that operates according to the control program stored in the storage 60.

In addition, the controller 6 controls performing of the printing process of forming the image according to the print data Img on the recording paper P by controlling the head unit 10 and the transport mechanism 7 on the basis of the print data Img and the like supplied from the host computer 9.

Specifically, the controller 6, first, stores the print data Img supplied from the host computer 9 in the storage 60.

Next, the controller 6 generates signals such as a printing signal SI (an example of “specification signal”) that controls operation of the head unit 10 to drive the discharger D and a drive waveform signal Com on the basis of a variety of data such as the print data Img stored in the storage 60. In addition, the controller 6 generates a clock signal CL that controls operation of the head unit 10.

In addition, the controller 6 generates a signal that controls operation of the motor driver 72 on the basis of the printing signal SI or of a variety of data stored in the storage 60 and outputs these various generated signals. As described in detail later, the drive waveform signal Com according to the present embodiment includes drive waveform signals Com-A and Com-B.

The drive waveform signal Com is an analog signal. Thus, the controller 6 includes a waveform signal generator (not illustrated) that includes a DA converter circuit or the like to convert a digital drive waveform signal generated by the CPU or the like included in the controller 6 into the analog drive waveform signal Com.

As such, the controller 6 drives the transport motor 71 to transport the recording paper P in the +X direction by controlling the motor driver 72 and controls whether to discharge ink from the discharger D, the amount of ink discharged, the timing of discharging ink, and the like by controlling the head unit 10. Accordingly, the controller 6 adjusts the size and arrangement of dots formed by ink discharged to the recording paper P and controls performing of the printing process of forming the image corresponding to the print data Img on the recording paper P.

In addition, as described in detail later, the controller 6 controls performing of a discharge state determination process of determining whether the state of ink discharged from the discharger D is normal.

As illustrated in FIG. 1, the head unit 10 includes a recording head 3 and a head driver 5. The recording head includes M dischargers D (M is a natural number greater than or equal to four in the present embodiment), and the head driver 5 drives each discharger D included in the recording head 3. Hereinafter, each of the M dischargers D will be referred to as a first stage, a second stage, . . . , and an M-th stage in order for distinguishing purposes. In addition, hereinafter, an m-th stage discharger D may be represented as a discharger D[m] (variable m is a natural number satisfying 1≦m≦M).

Each of the M dischargers D receives supply of ink from one of the four ink cartridges 31. Each discharger D is filled with the ink supplied from the ink cartridge 31 and is capable of discharging the ink filling therein from the nozzle N included in the discharger D. Specifically, each discharger D forms dots constituting the image on the recording paper P by discharging ink to the recording paper P at the timing of transport of the recording paper P onto the platen 74 performed by the transport mechanism 7. Then, discharging four CMYK color inks as a whole from the M dischargers D realizes full color printing.

The head driver 5 includes a drive signal supplier (an example of “supplier”) and a residual vibration detector 52 (an example of “detector”). The drive signal supplier 50 supplies the drive signal Vin that drives each of the M dischargers D included in the recording head 3 to each discharger D. The residual vibration detector 52 detects residual vibration that occurs in the discharger D after the discharger D is driven by the drive signal Vin.

The drive signal supplier 50 includes a drive signal generator 51 and a connector 53.

The drive signal generator 51 generates the drive signal Vin, which drives each of the M dischargers D included in the recording head 3, on the basis of the signals such as the printing signal SI, the clock signal CL, and the drive waveform signal Com supplied from the controller 6.

The connector 53 electrically connects each discharger D to one of the drive signal generator 51 and the residual vibration detector 52 on the basis of a connection control signal Sw that is supplied from the controller 6.

Then, the drive signal Vin generated by the drive signal generator 51 is supplied to the discharger D through the connector 53. Each discharger D, when being supplied with the drive signal Vin, is driven on the basis of the supplied drive signal Vin and is capable of discharging ink filling therein to the recording paper P.

The residual vibration detector 52 detects residual vibration that occurs in the discharger D after the discharger D is driven by the drive signal Vin as a residual vibration signal Vout. Then, the residual vibration detector 52 generates a shaped waveform signal Vd by processing the detected residual vibration signal Vout such as removing a noise component or amplifying the signal level and outputs the generated shaped waveform signal Vd as a result of detecting residual vibration in the discharger D. The drive signal supplier 50 and the residual vibration detector 52, for example, are mounted as electronic circuits on a substrate disposed in the head unit 10 in the present embodiment.

The discharge state determiner 4 determines the state of ink discharged in the discharger D on the basis of the shaped waveform signal Vd output by the residual vibration detector 52 and generates determination information RS that indicates the result of determination. The discharge state determiner 4, for example, is mounted as an electronic circuit on a substrate that is disposed at a different place from the head unit 10 in the present embodiment.

### 2. Configuration of Recording Head

The recording head 3 and the discharger D disposed in the recording head 3 will be described with reference to FIG. 3 and FIG. 4.

FIG. 3 is an example of a schematic partial sectional view of the recording head 3. For convenience of illustration, FIG. 3 illustrates only one of the M dischargers D included in the recording head 3, a reservoir 350 that communicates with the one discharger D through an ink supply port 360, and an ink intake port 370 that supplies ink from the ink cartridge 31 to the reservoir 350.

As illustrated in FIG. 3, the discharger D includes a piezoelectric element 300, a cavity 320 (an example of “pressure chamber”) filled with ink, the nozzle N communicating with the cavity 320, and a vibrating plate 310. The ink in the cavity 320 is discharged from the nozzle N by the discharger D when the piezoelectric element 300 is driven by the drive signal Vin. The cavity 320 of the discharger D is a space that is defined by a cavity plate 340, a nozzle plate 330, and the vibrating plate 310. The cavity plate 340 is formed into a predetermined shape having a recessed portion, and the nozzle plate 330 is where the nozzle N is formed. The cavity 320 communicates with the reservoir 350 through the ink supply port 360. The reservoir 350 communicates with one ink cartridge 31 through the ink intake port 370.

The present embodiment employs a unimorph (monomorph) type such as the one illustrated in FIG. 3 as the piezoelectric element 300. The piezoelectric element 300 is not limited to a unimorph type. A bimorph type, a multilayer type, or the like may be employed as well.

The piezoelectric element 300 includes a lower electrode 301, an upper electrode 302, and a piezoelectric body 303 that is disposed between the lower electrode 301 and the upper electrode 302. When a voltage is applied between the lower electrode 301 and the upper electrode 302 by setting the potential of the lower electrode 301 to a predetermined reference potential VSS and supplying the drive signal Vin to the upper electrode 302, the piezoelectric element 300 is bent (displaced) in the up-down direction of FIG. 3 in response to the applied voltage, and the piezoelectric element 300 vibrates in turn.

The vibrating plate 310 is installed in an upper face opening portion of the cavity plate 340, and the lower electrode 301 is bonded to the vibrating plate 310. Thus, the vibrating plate 310 vibrates when the piezoelectric element 300 is vibrated by the drive signal Vin. Then, the volume of the cavity 320 (pressure in the cavity 320) changes because of the vibration of the vibrating plate 310, and the ink filling the cavity 320 is discharged from the nozzle N. When the ink in the cavity 320 decreases because of an ink discharge, ink is supplied from the reservoir 350. In addition, ink is supplied to the reservoir 350 through the ink intake port 370 from the ink cartridge 31.

FIG. 4 is a descriptive diagram illustrating an example of arrangement of M nozzles N disposed in the recording head 3 when the ink jet printer 1 is viewed in a plan view either from the +Z direction or from the −Z direction.

As illustrated in FIG. 4, a nozzle array Ln that is configured of a plurality of nozzles N is disposed in four arrays in the recording head 3. Specifically, four nozzle arrays Ln configured of a nozzle array Ln-BK, a nozzle array Ln-CY, a nozzle array Ln-MG, and a nozzle array Ln-YL are disposed in the recording head 3. Each of the plurality of nozzles N belonging to the nozzle array Ln-BK is the nozzle N that is disposed in the discharger D discharging a black (BK) ink. Each of the plurality of nozzles N belonging to the nozzle array Ln-CY is the nozzle N that is disposed in the discharger D discharging a cyan (CY) ink. Each of the plurality of nozzles N belonging to the nozzle array Ln-MG is the nozzle N that is disposed in the discharger D discharging a magenta (MG) ink. Each of the plurality of nozzles N belonging to the nozzle array Ln-YL is the nozzle N that is disposed in the discharger D discharging a yellow (YL) ink. In addition, each of the four nozzle arrays Ln is disposed to extend in the +Y direction or in the −Y direction (hereinafter, the +Y direction and the −Y direction will be collectively referred to as “Y-axis direction”) when viewed in a plan view. A range YNL in which each nozzle array Ln extends in the Y-axis direction is greater than or equal to a range YP of the recording paper P in the Y-axis direction when printing is performed on the recording paper P (specifically, a recording paper P having a width in the Y-axis direction equal to the maximum printable width of the ink jet printer 1).

As illustrated in FIG. 4, the plurality of nozzles N constituting each nozzle array Ln is arranged into a so-called zigzag form in which the positions of the even nozzles N from the left (−Y side) of FIG. 4 differ from the positions of the odd nozzles N in the X-axis direction. The interval (pitch) between the nozzles N in the Y-axis direction in each nozzle array Ln may be appropriately set according to a printing resolution (dot per inch, dpi).

As described above, a plurality of dischargers D is disposed in correspondence with the plurality of nozzles N constituting each nozzle array Ln in the recording head 3. A plurality of cavities 320 that corresponds to the plurality of dischargers D is divided by the cavity plate 340. Hereinafter, a part of the cavity plate 340 that divides two adjacent cavities 320 will be referred to as “partition”.

For example, as illustrated in FIG. 4, when the discharger D[m] including the m-th stage nozzle N[m], the discharger D[m−1] including the (m−1)-th stage nozzle N[m−1], and the discharger D[m+1] including the (m+1)-th stage nozzle N[m+1] are adjacent to each other, partitions divide the cavity 320 included in the discharger D[m] from the cavity 320 included in the discharger D[m−1] and divide the cavity 320 included in the discharger D[m] from the cavity 320 included in the discharger D[m+1].

The printing process of the present embodiment, for example, assumes that, as illustrated in FIG. 4, the recording paper P is divided into a plurality of printing areas (for example, A4-size rectangular areas in a case of printing A4-size images on the recording paper P or labels of a label paper) and into a marginal area that divides each of the plurality of printing areas and that a plurality of images is formed in one-to-one correspondence with the plurality of printing areas.

### 3. Operation of Discharger and Residual Vibration

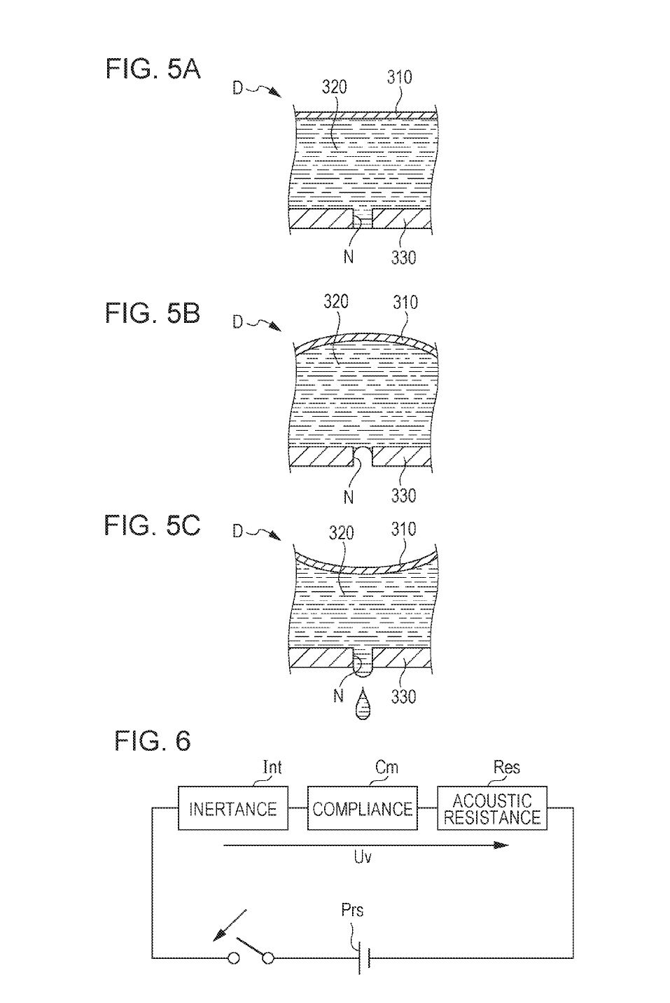

Next, an operation of discharging ink from the discharger D and residual vibration occurring in the discharger D will be described with reference to FIG. 5A to FIG. 13.

FIGS. 5A to 5C are descriptive diagrams illustrating an operation of discharging ink from the discharger D. In the state illustrated in FIG. 5A, when the drive signal Vin is supplied from the head driver 5 to the piezoelectric element 300 included in the discharger D, strain occurs in the piezoelectric element 300 in response to an electric field applied between the electrodes, and the vibrating plate 310 of the discharger D bends in the upward direction of FIG. 5A. Accordingly, as illustrated in FIG. 5B, the volume of the cavity 320 of the discharger D increases in comparison with the initial state illustrated in FIG. 5A. In the state illustrated in FIG. 5B, changing the potential of the drive signal Vin causes elastic restoring force of the vibrating plate 310 to restore the vibrating plate 310. The vibrating plate 310 is displaced in the downward direction of FIG. 5B beyond the initial position of the vibrating plate 310, and the volume of the cavity 320 instantaneously contracts as illustrated in FIG. 5C. At this time, compressive pressure occurring in the cavity 320 causes part of the ink filling the cavity 320 to be discharged as an ink drop from the nozzle N communicating with the cavity 320.

The vibrating plate 310 of the discharger D driven by the drive signal Vin is displaced in the up-down direction and vibrates as illustrated in FIGS. 5A to 5C. This vibration remains after the discharger D is driven by the drive signal Vin. Such residual vibration that remains in the discharger D after the discharger D is driven by the drive signal Vin is assumed to have a natural vibration frequency that is determined by an acoustic resistance Res that depends on the shape of the nozzle N or the ink supply port 360 or depends on the viscosity or the like of ink, an inertance Int that depends on the weight of ink in a channel, and a compliance Cm of the vibrating plate 310. Hereinafter, a calculation model based on the assumption for residual vibration occurring in the vibrating plate 310 of the discharger D will be described.

FIG. 6 is a circuit diagram illustrating a simple harmonic vibration calculation model that assumes residual vibration of the vibrating plate 310. As such, the calculation model for residual vibration of the vibrating plate 310 is represented by an acoustic pressure Prs, the inertance Int, the compliance Cm, and the acoustic resistance Res. The following expressions result from calculating a step response with respect to a volume velocity Uv at the time of applying the acoustic pressure Prs to the circuit of FIG. 6.

Uv={Prs/(ω−Int)}e^{-γt}·sin(ωt)

ω={1/(Int·Cm)−γ²}^{1/2}

γ=Res/(2·Int)

A calculation result (calculated value) obtained from the expressions is compared with an experimental result (experimental value) that is obtained from a residual vibration experiment separately performed on the discharger D. The residual vibration experiment is an experiment that detects residual vibration occurring in the vibrating plate 310 of the discharger D after discharging ink from the discharger D in which the state of ink discharged is normal.

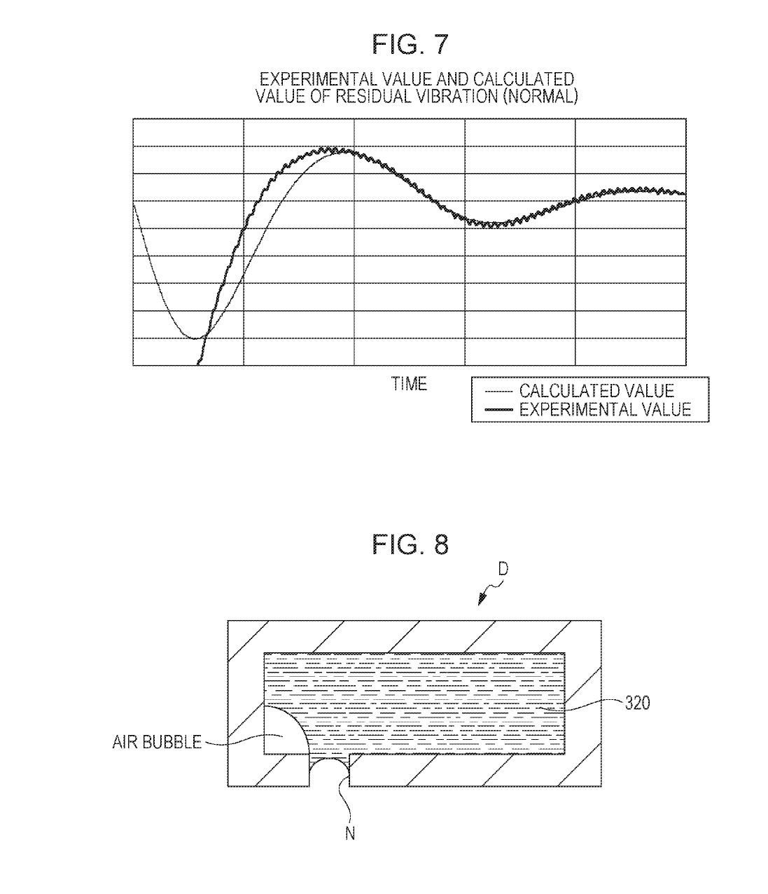

FIG. 7 is a graph illustrating a relationship between the experimental value and the calculated value of residual vibration. As understood from the graph illustrated in FIG. 7, two waveforms of the experimental value and the calculated value approximately match when the state of ink discharged in the discharger D is normal.

It may occur that an ink drop is not normally discharged from the nozzle N of the discharger D because of an abnormal state of ink discharged in the discharger D even if the discharger D performs an ink discharging operation. That is, an abnormal discharge may occur. Causes of the abnormal discharge are exemplified by (1) mingling of an air bubble in the cavity 320, (2) thickening or solidification of ink in the cavity 320 due to drying or the like of ink in the cavity 320, and (3) attachment of a foreign object such as paper dust near the outlet of the nozzle N.

As described above, the abnormal discharge typically means a state where ink cannot be discharged from the nozzle N. That is, a phenomenon where ink is not discharged occurs, in which case a dot is omitted at a pixel in the image printed on the recording paper P. In addition, in the case of the abnormal discharge, as described above, ink may not hit the recording paper P correctly even if ink is discharged from the nozzle N because either the amount of ink is excessively small or the flying direction (trajectory) of the discharged ink drop is shifted, thereby resulting in omitting a dot at a pixel.

Below, at least one value of the acoustic resistance Res and the inertance Int will be adjusted to approximately match the calculated value and the experimental value of residual vibration on the basis of the comparison result illustrated in FIG. 7 for each cause of the abnormal discharge occurring in the discharger D.

First, (1) mingling of an air bubble in the cavity 320, which is one of the causes of the abnormal discharge, will be reviewed. FIG. 8 is a conceptual diagram illustrating a case where an air bubble mingles in the cavity 320. As illustrated in FIG. 8, when an air bubble mingles in the cavity 320, the total weight of the ink filling the cavity 320 is reduced, and the inertance Int is considered to be decreased. In addition, when the air bubble is attached near the nozzle N, the diameter of the nozzle N is deemed to be increased by the size of the diameter of the air bubble, and the acoustic resistance Res is considered to be decreased.

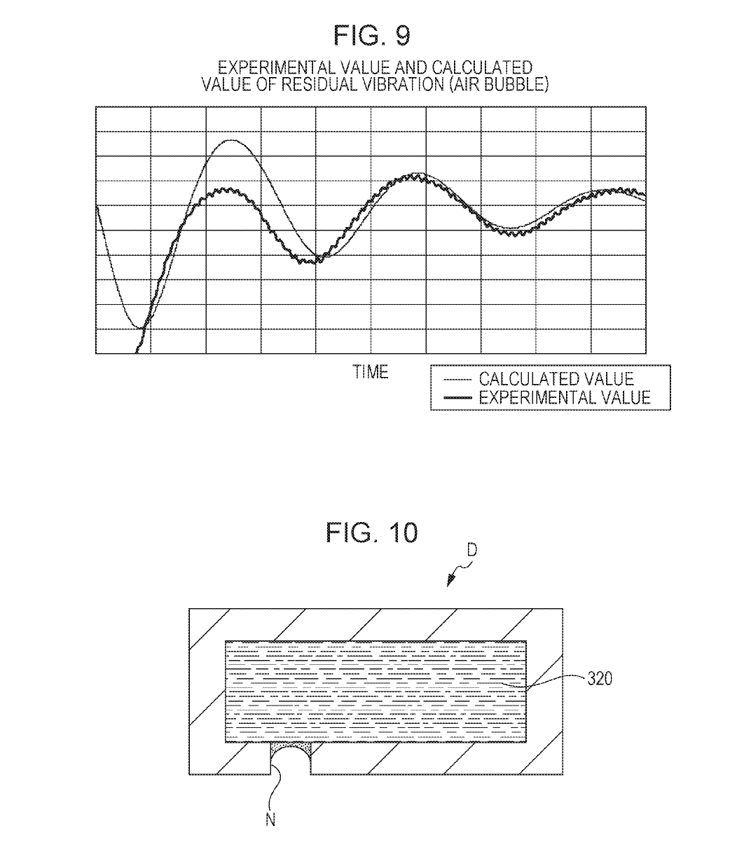

Therefore, the experimental value and the calculated value of residual vibration at the time of mingling of the air bubble are matched by setting the acoustic resistance Res and the inertance Int to be smaller than those in the case as illustrated in FIG. 7 where the state of ink discharged is normal, and this results in the graph illustrated in FIG. 9. As illustrated in FIG. 7 and FIG. 9, when mingling of an air bubble in the cavity 320 causes an abnormal discharge, the frequency of residual vibration increases in comparison with a case where the state of discharge is normal. It can also be observed that the rate of attenuation of the amplitude of residual vibration decreases because of a decrease in the acoustic resistance Res and the like and that the amplitude of residual vibration decreases slowly.

Next, (2) thickening or solidification of ink in the cavity 320, which is one of the causes of the abnormal discharge, will be reviewed. FIG. 10 is a conceptual diagram illustrating a case where ink dries and solidifies near the nozzle N of the cavity 320. As illustrated in FIG. 10, when ink dries and solidifies near the nozzle N, the ink in the cavity 320 becomes confined to the cavity 320. In such a case, the acoustic resistance Res is considered to be increased.

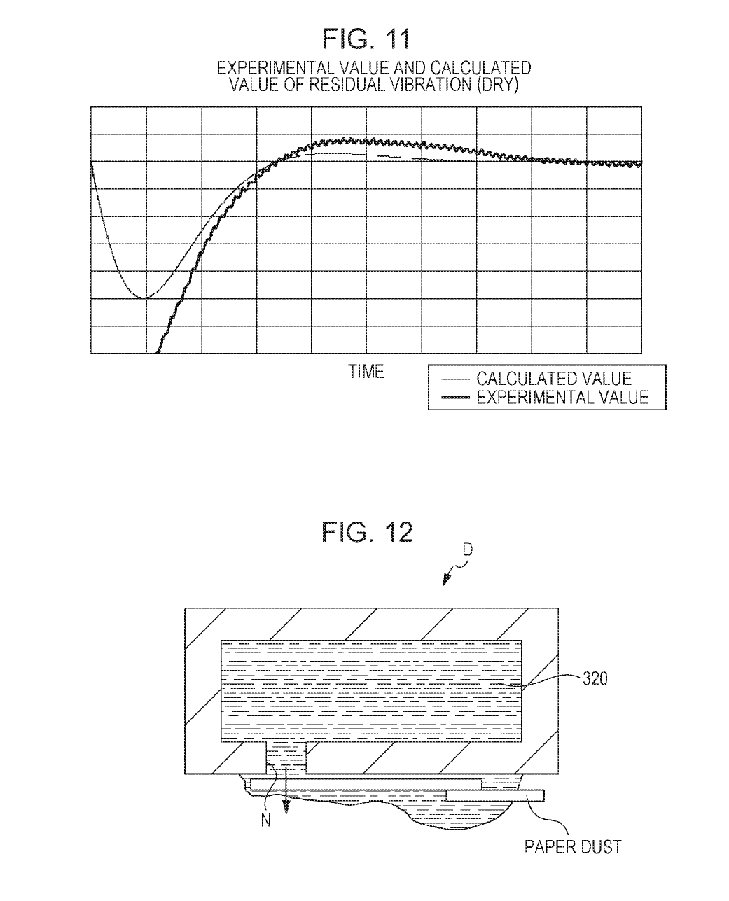

Therefore, the experimental value and the calculated value of residual vibration in the case where ink solidifies or thickens near the nozzle N are matched by setting the acoustic resistance Res to be greater than that in the case as illustrated in FIG. 7 where the state of ink discharged is normal, and this results in the graph illustrated in FIG. 11. The experimental value illustrated in FIG. 11 results from measuring residual vibration of the vibrating plate 310 included in the discharger D in a state where ink solidifies near the nozzle N after the discharger D is left for several days with an unillustrated cap not mounted thereon. As illustrated in FIG. 7 and FIG. 11, when ink solidifies near the nozzle N in the cavity 320, the frequency of residual vibration significantly decreases in comparison with a case where the state of discharge is normal, and a characteristic waveform in which the residual vibration is excessively attenuated is obtained. This is because the vibrating plate 310 cannot instantaneously vibrate (excessively attenuated) when the vibrating plate 310 moves in the −Z direction (downward) after the vibrating plate 310 that is drawn in the +Z direction (upward) to discharge ink causes ink to flow into the cavity 320 from the reservoir, since there is no way of escape for the ink in the cavity 320.

Next, (3) attachment of a foreign object such as paper dust near the outlet of the nozzle N, which is one of the causes of the abnormal discharge, will be reviewed. FIG. 12 is a conceptual diagram illustrating a case where paper dust is attached near the outlet of the nozzle N. As illustrated in FIG. 12, when paper dust is attached near the outlet of the nozzle N, ink oozes from the cavity 320 through the paper dust, and ink cannot be discharged from the nozzle N. When the attachment of paper dust near the outlet of the nozzle N causes ink to ooze from the nozzle N, the amount of ink oozing from the cavity 320 is increased from the case where the state of discharge is normal when viewed from the vibrating plate 310. Thus, the inertance Int is considered to be increased. In addition, the acoustic resistance Res is considered to be increased by the fibers of the paper dust attached near the outlet of the nozzle N.

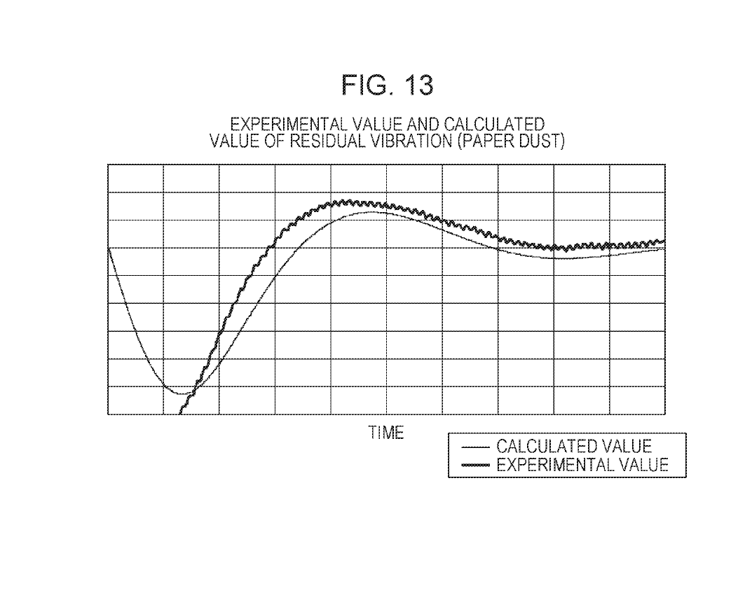

Therefore, the experimental value and the calculated value of residual vibration when paper dust is attached near the outlet of the nozzle N are matched by setting the inertance Int and the acoustic resistance Res to be greater than those in the case as illustrated in FIG. 7 where the state of ink discharged is normal, and this results in the graph illustrated in FIG. 13. As understood from the graphs of FIG. 7 and FIG. 13, when paper dust is attached near the outlet of the nozzle N, the frequency of residual vibration decreases in comparison with the case where the state of discharge is normal.

In addition, it is understood from the graphs illustrated in FIG. 11 and FIG. 13 that the frequency of residual vibration is greater in the case (3) attachment of a foreign object such as paper dust near the outlet of the nozzle N than in the case (2) thickening of ink in the cavity 320.

The frequency of residual vibration is smaller in either of the cases (2) thickening of ink and (3) attachment of paper dust near the outlet of the nozzle N than in the case where the state of ink discharged is normal. These two causes of the abnormal discharge can be distinguished from each other by comparing the waveform of residual vibration, specifically, the frequency or cycle of residual vibration with a predetermined threshold.

It is apparent from the above description that the state of discharge of the discharger D can be determined on the basis of the waveform of residual vibration, particularly, the frequency or cycle of residual vibration that occurs when the discharger D is driven. More specifically, on the basis of the frequency or cycle of residual vibration, it is possible to determine whether the state of discharge is normal in the discharger D and which one of (1) to (3) is the cause of the abnormal discharge when the state of discharge is abnormal in the discharger D. The ink jet printer 1 according to the present embodiment performs the discharge state determination process of determining the state of discharge by analyzing residual vibration.

### 4. Configuration and Operation of Head Driver

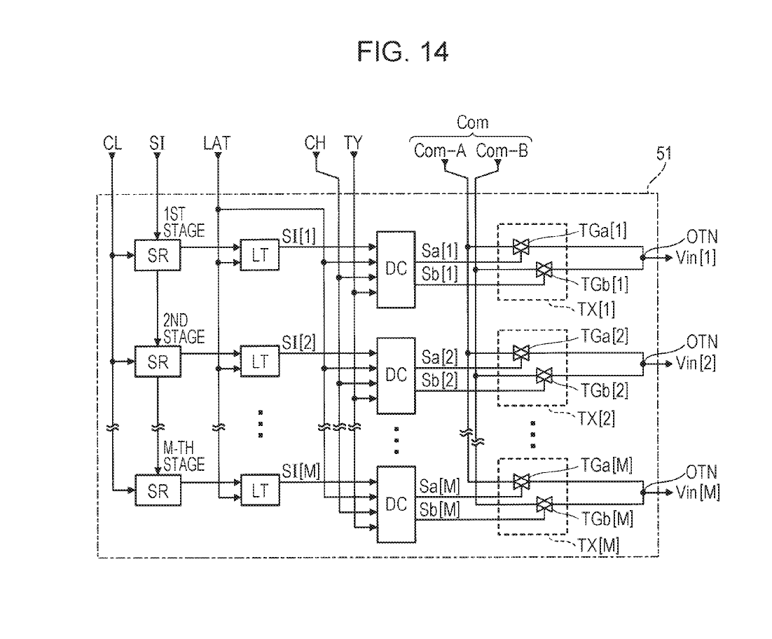

Next, the head driver 5 (the drive signal generator 51, the residual vibration detector 52, and the connector 53) and the discharge state determiner 4 will be described with reference to FIG. 14 to FIG. 21.

### 4. 1. Drive Signal Generator

FIG. 14 is a block diagram illustrating a configuration of the drive signal generator 51 of the head driver 5.

As illustrated in FIG. 14, the drive signal generator 51 includes M sets of a shift register SR, a latch circuit LT, a decoder DC, and a switch TX in one-to-one correspondence with the M dischargers D. Hereinafter, each element constituting these M sets may be referred to as a first stage, a second stage, . . . , and an M-th stage in order from the top of FIG. 14.

The drive signal generator 51 is supplied with the clock signal CL, the printing signal SI, a latch signal LAT, a change signal CH, a process type signal TY, and the drive waveform signal Com (Com-A and Com-B) from the controller 6.

The drive waveform signal Com (Com-A and Com-B) is a signal that includes a plurality of waveforms driving the discharger D.

The printing signal SI specifies whether to supply the drive waveform signal Com to each discharger D and the waveform of the drive waveform signal Com to be supplied to the discharger D that is a supply target of the drive waveform signal Com. Accordingly, the printing signal SI is a digital signal that specifies at least one of whether to drive each discharger D, whether to discharge ink from each discharger D, and the amount of ink to be discharged from each discharger D.

The printing signal SI includes printing signals SI[1] to SI[M]. Of the printing signals SI[1] to SI[M], the printing signal SI[m] specifies at least one of whether to drive the discharger D[m], whether to discharge ink from the discharger D[m], and the amount of ink to be discharged from the discharger D[m] in two bits of a high-order bit b1 and a low-order bit b2.

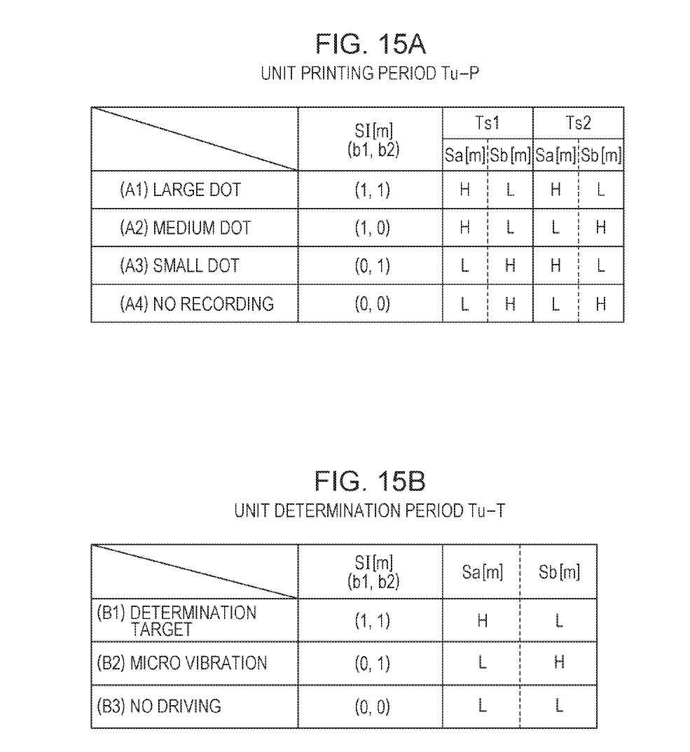

Specifically, the printing signal SI[m], when the ink jet printer 1 performs the printing process, specifies one of discharging the amount of ink corresponding to a large dot, discharging the amount of ink corresponding to a medium dot, discharging the amount of ink corresponding to a small dot, and not discharging ink with respect to the discharger D[m] (refer to FIG. 15A).

Meanwhile, the printing signal SI[m], when the ink jet printer 1 performs the discharge state determination process, specifies one of generating residual vibration for inspecting the state of discharge in the discharger D[m], generating micro vibration for preventing thickening of ink in the discharger D[m], and stopping driving of the discharger D[m] (attenuating vibration of the discharger D[m]) (refer to FIG. 15B).

The drive signal generator 51 supplies the drive signal Vin having a waveform specified by the printing signal SI[m] to the discharger D[m] when the printing signal SI[m] specifies the waveform of the drive waveform signal Com to be supplied to the discharger D[m]. Hereinafter, the drive signal Vin that has a waveform specified by the printing signal SI[m] and is supplied to the discharger D[m] will be referred to as a drive signal Vin[m].

The drive signal generator 51 does not generate the drive signal Vin[m] and stops supply of the drive signal Vin[m] to the discharger D[m] when the printing signal SI[m] does not specify the waveform of the drive waveform signal Com to be supplied to the discharger D[m].

The shift register SR has a configuration in which the printing signal SI (SI[1] to SI[M]) that is serially supplied is temporarily retained in two bits corresponding to each discharger D. Specifically, the M shift registers SR of the first stage, the second stage, . . . , and the M-th stage that correspond one-to-one to the M dischargers D are connected in cascade, and the printing signal SI that is serially supplied is sequentially transmitted to the subsequent stage of the shift register SR according to the clock signal CL. When the printing signal SI is transmitted through all of the M shift registers SR, each of the M shift registers SR maintains a state where the corresponding two bits of the data of the printing signal SI are retained therein. Hereinafter, the m-th stage shift register SR may be referred to as a shift register SR[m].

Each of the M latch circuits LT simultaneously latches two bits of the printing signal SI[m], corresponding to each stage, retained in each of the M shift registers SR at the timing of a rise of the latch signal LAT. That is, the m-th stage latch circuit LT latches the printing signal SI[m] that is retained by the shift register SR[m].

An operation period that is a period during which the ink jet printer 1 performs at least one of the printing process and the discharge state determination process is configured of a plurality of unit periods Tu.

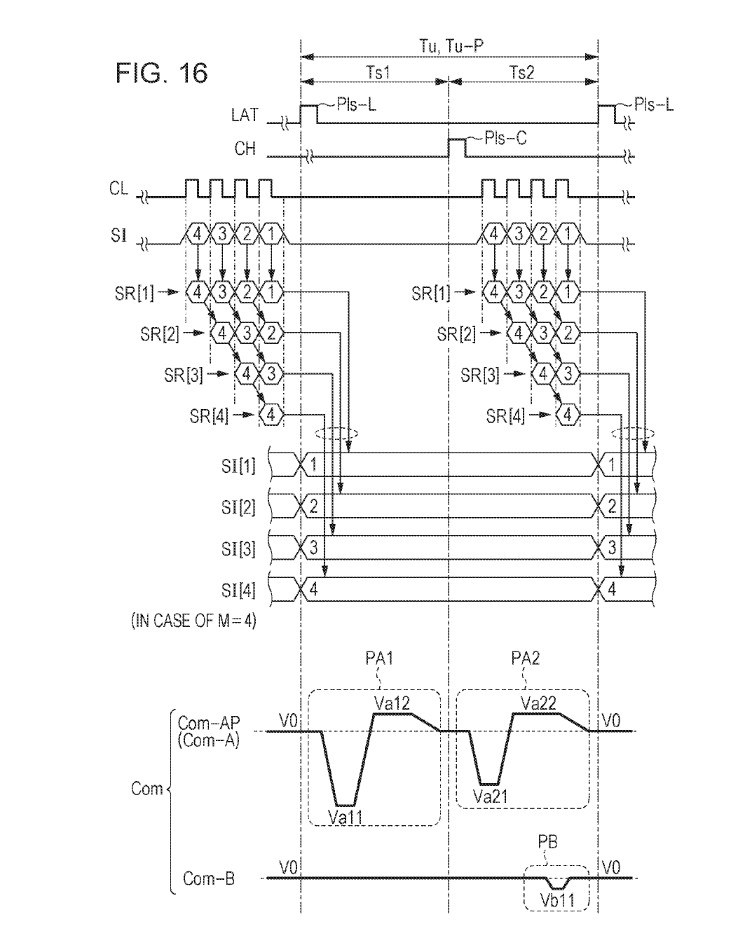

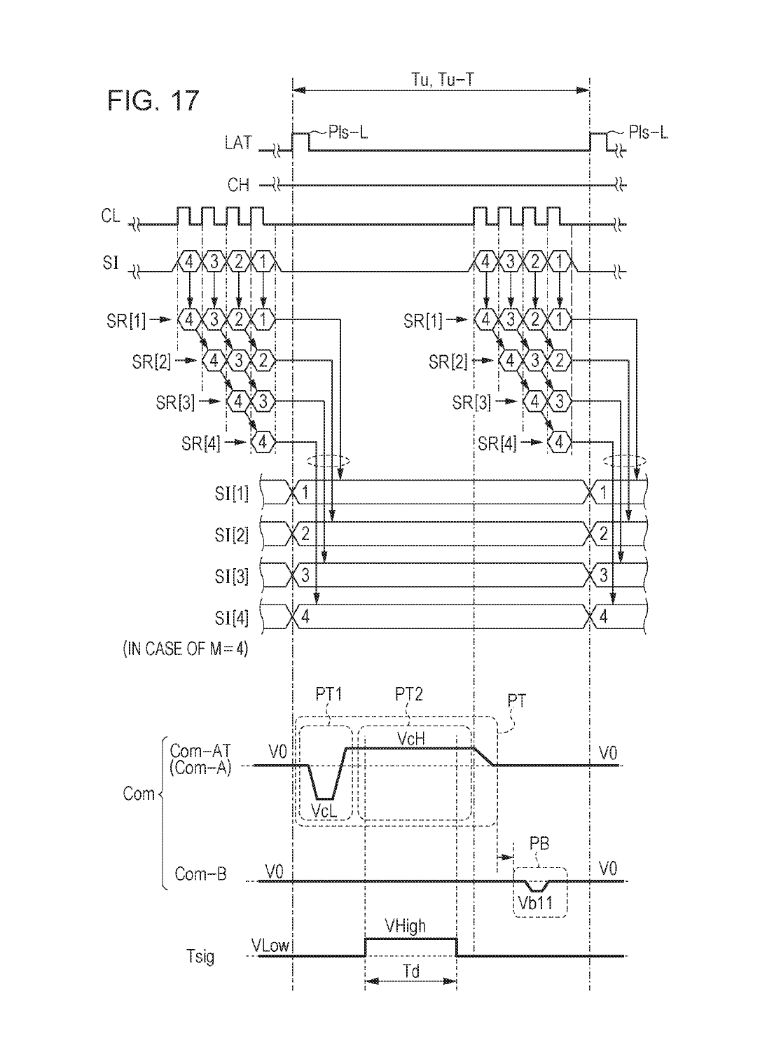

In the present embodiment, the unit period Tu is classified into two types of unit period Tu: a unit printing period Tu-P that is a unit period Tu during which the printing process is performed (refer to FIG. 16) and a unit determination period Tu-T that is a unit period Tu during which the discharge state determination process is performed (refer to FIG. 17).

As described above, the ink jet printer 1 according to the present embodiment divides the recording paper P having a long shape into the plurality of printing areas and the marginal area dividing each of the plurality of printing areas and forms one image in each printing area.

Specifically, the controller 6 classifies a period, of the plurality of unit periods Tu constituting the operation period, during which at least a part of the printing area of the recording paper P is positioned under the recording head 3 (−Z side) as the unit printing period Tu-P and controls operation of each unit of the ink jet printer 1 such that the printing process is performed during the unit printing period Tu-P.

Meanwhile, the controller 6 classifies a period, of the plurality of unit periods Tu constituting the operation period, during which only the marginal area of the recording paper P is positioned under the recording head 3 (−Z side) as the unit determination period Tu-T and controls operation of each unit of the ink jet printer 1 such that the discharge state determination process is performed during the unit determination period Tu-T.

The controller 6 outputs the process type signal TY for each unit period Tu to indicate the type of process that is performed by the ink jet printer 1 during each unit period Tu. That is, the controller 6 outputs the process type signal TY that is set to a value indicating performing of the printing process when the unit printing period Tu-P is started or outputs the process type signal TY that is set to a value indicating performing of the discharge state determination process when the unit determination period Tu-T is started.

The controller 6 supplies the printing signal SI to the drive signal generator 51 for each unit period Tu and also supplies the latch signal LAT causing the latch circuit LT to latch the printing signal SI[m] to the drive signal generator 51 for each unit period Tu.

Specifically, the controller 6 supplies the process type signal TY indicating performing of the printing process to the drive signal generator 51 during the unit printing period Tu-P. Then, the controller 6 controls the drive signal generator 51 such that the drive signal Vin for the printing process is supplied during the unit printing period Tu-P to the discharger D[m] to perform the printing process. The drive signal Vin for the printing process is a drive signal Vin that drives the discharger D such that the discharger D performs one of discharging the amount of ink corresponding to a large dot, discharging the amount of ink corresponding to a medium dot, discharging the amount of ink corresponding to a small dot, and not discharging ink.

The controller 6 supplies the process type signal TY indicating performing of the discharge state determination process to the drive signal generator 51 during the unit determination period Tu-T. Then, the controller 6 controls the drive signal generator 51 such that the drive signal Vin for the discharge state determination process is supplied during the unit determination period Tu-T to the discharger D[m] that is to be supplied with the drive waveform signal Com to perform the discharge state determination process. The drive signal Vin for the discharge state determination process is a drive signal Vin that drives the discharger D such that residual vibration or micro vibration occurs in the discharger D.

The controller 6 divides the unit printing period Tu-P of the unit period Tu into a control period Ts1 and a control period Ts2 with the change signal CH in the present embodiment. The control periods Ts1 and Ts2 have the same length in time.

The decoder DC decodes the printing signal SI[m] latched by the latch circuit LT according to the type of process indicated by the process type signal TY and outputs selection signals Sa[m] and Sb[m].

FIGS. 15A and 15B are descriptive diagrams illustrating the content of decoding performed by the decoder DC during each unit period Tu. FIG. 15A illustrates the content of decoding performed by the m-th stage decoder DC during the unit printing period Tu-P, and FIG. 15B illustrates the content of decoding performed by the m-th decoder DC during the unit determination period Tu-T.

As illustrated in FIG. 15A, the m-th stage decoder DC outputs the selection signals Sa[m] and Sb[m] during each of the control periods Ts1 and Ts2 of the unit printing period Tu-P. For example, when the printing signal SI[m] is (b1, b2)=(1, 0) during the unit printing period Tu-P (refer to the part (A2) of FIG. 15A), the m-th stage decoder DC respectively sets the selection signal Sa[m] and the selection signal Sb[m] to a high level H and to a low level L during the control period Ts1 and respectively sets the selection signal Sb[m] and the selection signal Sa[m] to the high level H and to the low level L during the control period Ts2.

In addition, the m-th stage decoder DC outputs only the selection signal Sa[m] or only the selection signal Sb[m] during the unit determination period Tu-T as illustrated in FIG. 15B. For example, when the printing signal SI[m] is (b1, b2)=(1, 1) during the unit determination period Tu-T (refer to the part (B1) of FIG. 15B), the m-th stage decoder DC maintains the selection signal Sa[m] at the high level H and maintains the selection signal Sb[m] at the low level L through the unit determination period Tu-T.

As illustrated in FIG. 14, the drive signal generator 51 includes the M switches TX in one-to-one correspondence with the M dischargers D. The m-th stage switch TX[m] includes a transmission gate TGa[m] and a transmission gate TGb[m]. The transmission gate TGa[m] is ON when the selection signal Sa[m] is at the level H and is OFF when the selection signal Sa[m] is at the level L. The transmission gate TGb[m] is ON when the selection signal Sb[m] is at the level H and is OFF when the selection signal Sb[m] is at the level L.

For example, when the printing signal SI[m] indicates (1, 0) during the unit printing period Tu-P, the transmission gate TGa[m] is ON while the transmission gate TGb[m] is OFF during the control period Ts1, and then, the transmission gate TGa[m] is OFF while the transmission gate TGb[m] is ON during the control period Ts2.

As illustrated in FIG. 14, the drive waveform signal Com-A is supplied to one terminal of the transmission gate TGa[m], and the drive waveform signal Com-B is supplied to one terminal of the transmission gate TGb[m]. The other terminals of the transmission gates TGa[m] and TGb[m] are electrically connected to an m-th stage output terminal OTN.

Thus, when the printing signal SI[m] specifies driving of the discharger D[m], the switch TX[m] is controlled such that one of the transmission gates TGa[m] and TGb[m] is ON. Accordingly, the switch TX[m] supplies one of the drive waveform signals Com-A and Com-B as the drive signal Vin[m] to the discharger D[m] through the m-th stage output terminal OTN during the unit period Tu of driving the discharger D[m].

The printing signal SI[m] specifying driving of the discharger D[m] means that the printing signal SI[m] specifies at least one of the waveforms included in the drive waveform signal Com, and this applies to the parts (A1) to (A4), (B1), and (B2) of FIGS. 15A and 15B.

Meanwhile, when the printing signal SI[m] specifies non-driving of the discharger D[m], the switch TX[m] is controlled such that both of the transmission gates TGa[m] and TGb[m] are OFF. Accordingly, the switch TX[m] stops supply of the drive signal Vin[m] to the discharger D[m] during the unit period Tu of not driving the discharger D[m].

The printing signal SI[m] specifying non-driving of the discharger D[m] means that the printing signal SI[m] does not specify any of the waveforms included in the drive waveform signal Com, and this applies to the part (B3) of FIG. 15B.

### 4. 2. Drive Waveform Signal

FIG. 16 and FIG. 17 are timing charts illustrating various signals supplied by the controller 6 to the drive signal generator 51 during each unit period Tu and operation of the drive signal generator 51 during each unit period Tu. FIG. 16 is an example of operation of the drive signal generator 51 and of signals supplied to the drive signal generator 51 during the unit printing period Tu-P, and FIG. 17 is an example of operation of the drive signal generator 51 and of signals supplied to the drive signal generator 51 during the unit determination period Tu-T. For convenience of illustration, FIG. 16 and FIG. 17 illustrate a case of M=4.

As illustrated in FIG. 16 and FIG. 17, the unit periods Tu are divided by a pulse Pls-L that is included in the latch signal LAT output by the controller 6. In addition, the control periods Ts1 and Ts2 of the unit printing period Tu-P are divided by a pulse Pls-C that is included in the change signal CH output by the controller 6.

The controller 6 supplies the printing signal SI in synchronization with the clock signal CL to the drive signal generator 51 before the start of each unit period Tu. Then, the shift register SR of the drive signal generator 51 sequentially transmits the supplied printing signal SI[m] to the subsequent stage thereof according to the clock signal CL.

As illustrated in FIG. 16 and FIG. 17, the waveform of the drive waveform signal Com-A output by the controller 6 is different in the unit printing period Tu-P and in the unit determination period Tu-T in the present embodiment. The controller 6 selects the waveform of the drive waveform signal Com-A according to the type of process indicated by the process type signal TY.

Hereinafter, the drive waveform signal Com-A that is output by the controller 6 during the unit printing period Tu-P will be referred to as a printing drive waveform signal Com-AP (refer to FIG. 16). In addition, the drive waveform signal Com-A that is output by the controller 6 during the unit determination period Tu-T will be referred to as a determination drive waveform signal Com-AT (refer to FIG. 17).

As illustrated in FIG. 16, the printing drive waveform signal Com-AP that is output by the controller 6 during the unit printing period Tu-P includes a discharge waveform PA1 (hereinafter, referred to as “waveform PA1”) that is provided during the control period Ts1 and a discharge waveform PA2 (hereinafter, referred to as “waveform PA2”) that is provided during the control period Ts2.

The waveform PA1 is a waveform that causes the discharger D[m] to discharge a medium amount of ink corresponding to a medium dot when the drive signal Vin[m] including the waveform PA1 is supplied to the discharger D[m].

The waveform PA2 is a waveform that causes the discharger D[m] to discharge a small amount of ink corresponding to a small dot when the drive signal Vin[m] including the waveform PA2 is supplied to the discharger D[m].

The potential difference, for example, between a minimum potential Va11 and a maximum potential Va12 of the waveform PA1 is set to be greater than the potential difference between a minimum potential Va21 and a maximum potential Va22 of the waveform PA2.

As illustrated in FIG. 16 and FIG. 17, the drive waveform signal Com-B that is output by the controller 6 during the unit periods Tu of both of the unit printing period Tu-P and the unit determination period Tu-T includes a micro vibration waveform PB (hereinafter, referred to as “waveform PB”).

The waveform PB is a waveform that causes the discharger D[m] not to discharge ink when the drive signal Vin[m] including the waveform PB is supplied to the discharger D[m]. That is, the waveform PB is a waveform that prevents thickening of ink by applying micro vibration to the ink inside the discharger D. The potential difference, for example, between a minimum potential Vb11 and the maximum potential (a reference potential V0 in this example) of the waveform PB is set to be smaller than the potential difference between the minimum potential Va21 and the maximum potential Va22 of the waveform PA2.

As illustrated in FIG. 17, the determination drive waveform signal Com-AT that is output by the controller 6 during the unit determination period Tu-T includes an inspection waveform PT (hereinafter, referred to as “waveform PT”). In the present embodiment, the waveform PB is arranged to be started after the end of the waveform PT during each unit period Tu. That is, the waveform PT is arranged to temporally precede the waveform PB.

The waveform PT includes a waveform PT1 that vibrates the discharger D and a waveform PT2 that maintains residual vibration of the discharger D after the discharger D is driven by the waveform PT1 in the present embodiment.

The waveform PT1 is a waveform that causes the discharger D[m] not to discharge ink when the drive signal Vin[m] including the waveform PT1 is supplied to the discharger D[m]. The potential difference, for example, between a minimum potential VcL and the maximum potential (a detection potential VcH in this example) of the waveform PT1 is set to be smaller than the potential difference between the minimum potential Va21 and the maximum potential Va22 of the waveform PA2. That is, the discharge state determination process according to the present embodiment assumes so-called “inspection without discharging” in which the state of ink discharged in the discharger D is determined on the basis of residual vibration that occurs in the discharger D when the discharger D is driven in a manner not discharging ink.

However, the waveform PT1 may be a waveform that causes the discharger D[m] to discharge ink when the drive signal Vin[m] including the waveform PT1 is supplied to the discharger D[m]. That is, the discharge state determination process may be performed as “inspection with discharging”.

The waveform PT2 is a flat waveform that maintains the potential thereof at the detection potential VcH. By supplying the drive signal Vin[m] that includes the waveform PT2 to the discharger D[m] immediately after driving the discharger D[m] with the drive signal Vin[m] that includes the waveform PT1, residual vibration that occurs in the discharger D[m] from driving of the discharger D[m] by the waveform PT1 can be maintained, and thus, the residual vibration can be accurately detected.

The residual vibration detector 52 detects residual vibration occurring in the discharger D[m] as the residual vibration signal Vout during a detection period Td that is included in a period, included in the unit determination period Tu-T during which the determination drive waveform signal Com-AT is supplied to the discharger D[m], during which the waveform PT2 is supplied to the discharger D[m] while the drive signal Vin[m] maintains the detection potential VcH.

The detection period Td is defined in the present embodiment as a period during which a detection period specifying signal Tsig that is output by the controller 6 is at a predetermined potential VHigh as illustrated in FIG. 17. The detection period Td is arranged before the start of a period during which the shift register SR is supplied with the clock signal CL and transmits the printing signal SI[m] in the present embodiment.

### 4. 3. Drive Signal

Next, the drive signal Vin that is output by the drive signal generator 51 during the unit period Tu will be described.

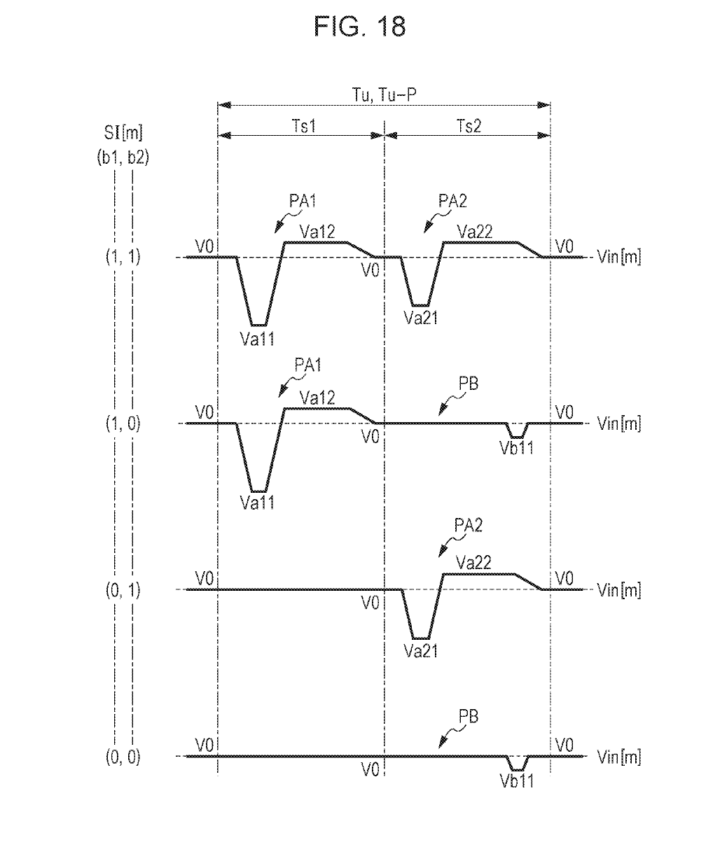

First, the drive signal Vin for the printing process that is output by the drive signal generator 51 during the unit printing period Tu-P will be described with reference to FIG. 18.

The switch TX[m], when the printing signal SI[m] supplied during the unit printing period Tu-P indicates (1, 1), selects the drive waveform signal Com-A and outputs the drive signal Vin[m] including the waveform PA1 during the control period Ts1 and, then, selects the drive waveform signal Com-A and outputs the drive signal Vin[m] including the waveform PA2 during the control period Ts2 (refer to the part (A1) of FIG. 15A). In this case, as illustrated in FIG. 18, the drive signal Vin[m] that is supplied to the discharger D[m] during the unit printing period Tu-P includes the waveform PA1 and the waveform PA2. As a consequence, the discharger D[m] discharges a medium amount of ink based on the waveform PA1 and a small amount of ink based on the waveform PA2 during the unit printing period Tu-P, and the two discharges of ink form a large dot on the recording paper P.

The switch TX[m], when the printing signal SI[m] supplied during the unit printing period Tu-P indicates (1, 0), selects the drive waveform signal Com-A and outputs the drive signal Vin[m] including the waveform PA1 during the control period Ts1 and, then, selects the drive waveform signal Com-B and outputs the drive signal Vin[m] including the waveform PB during the control period Ts2 (refer to the part (A2) of FIG. 15A). In this case, as illustrated in FIG. 18, the drive signal Vin[m] that is supplied to the discharger D[m] during the unit printing period Tu-P includes the waveform PA1 and the waveform PB. As a consequence, the discharger D[m] discharges a medium amount of ink based on the waveform PA1 during the unit printing period Tu-P and forms a medium dot on the recording paper P.

The switch TX[m], when the printing signal SI[m] supplied during the unit printing period Tu-P indicates (0, 1), selects the drive waveform signal Com-B and outputs the drive signal Vin[m] including the waveform PB during the control period Ts1 and, then, selects the drive waveform signal Com-A and outputs the drive signal Vin[m] including the waveform PA2 during the control period Ts2 (refer to the part (A3) of FIG. 15A). In this case, as illustrated in FIG. 18, the drive signal Vin[m] that is supplied to the discharger D[m] during the unit printing period Tu-P includes the waveform PA2. As a consequence, the discharger D[m] discharges a small amount of ink based on the waveform PA2 during the unit printing period Tu-P and forms a small dot on the recording paper P.

The switch TX[m], when the printing signal SI[m] supplied during the unit printing period Tu-P indicates (0, 0), selects the drive waveform signal Com-B and outputs the drive signal Vin[m] including the waveform PB during the control periods Ts1 and Ts2 (refer to the part (A4) of FIG. 15A). That is, in this case, as illustrated in FIG. 18, the drive signal Vin[m] that is supplied to the discharger D[m] during the unit printing period Tu-P includes the waveform PB. As a consequence, the discharger D[m] does not discharge ink during the unit printing period Tu-P and does not form any dot on the recording paper P (performs no recording).

Next, the drive signal Vin for the discharge state determination process that is output by the drive signal generator 51 during the unit determination period Tu-T will be described.

First, the switch TX[m], when the printing signal SI[m] supplied during the unit determination period Tu-T indicates (1, 1), selects the waveform signal Com-A and supplies the drive signal Vin[m] including the waveform PT to the discharger D[m] during the unit determination period Tu-T (refer to the part (B1) of FIG. 15B).

When the printing signal SI[m] supplied during the unit determination period Tu-T indicates (0, 1), the switch TX[m] selects the drive waveform signal Com-B and supplies the drive signal Vin[m] including the waveform PB to the discharger D[m] during the unit determination period Tu-T (refer to the part (B2) of FIG. 15B).

When the printing signal SI[m] supplied during the unit determination period Tu-T indicates (0, 0), the switch TX[m] does not select any of the drive waveform signals Com-A and Com-B and stops supply of the drive signal Vin[m] to the discharger D[m] during the unit determination period Tu-T (refer to the part (B3) of FIG. 15B).

Both of the transmission gates TGa[m] and TGb[m] are OFF when the printing signal SI[m] indicating (0, 0) causes the switch TX[m] not to select any of the drive waveform signals Com-A and Com-B. In addition, as illustrated in FIG. 16 and FIG. 17, the potential of the drive waveform signal Com is set to the reference potential V0 at the start and the end of the unit period Tu in the present embodiment.

Thus, when the switch TX[m] does not select any of the drive waveform signals Com-A and Com-B and stops supply of the drive signal Vin[m] to the discharger D[m] during the unit determination period Tu-T, the potential of an interconnect that electrically connects the output terminal OTN to the upper electrode 302 is maintained at approximately the same potential as the reference potential V0 because of the capacitance and the like of the piezoelectric element 300 of the discharger D[m].

As described in detail later, when the discharger D[m] is the target of the discharge state determination process in one unit period Tu, the controller 6 sets the value of the printing signal SI[m] to (1, 1) during the one unit period Tu so as to supply the drive signal Vin[m] including the waveform PT to the discharger D[m].

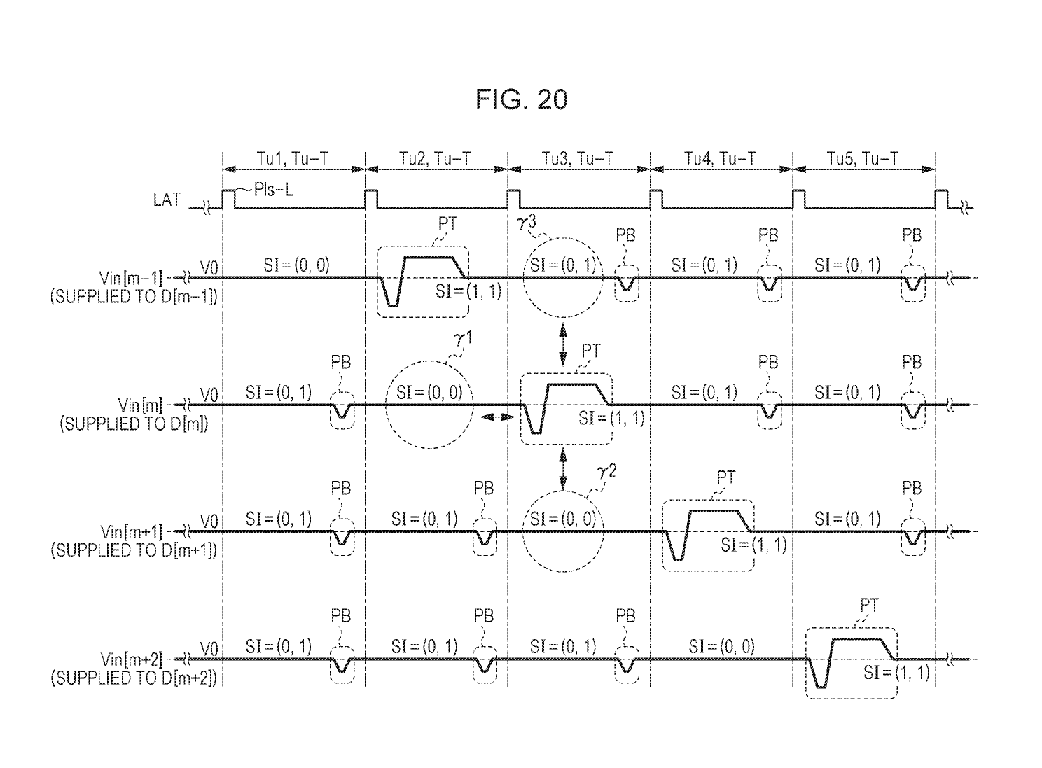

When the discharger D[m] is the target of the discharge state determination process in the unit period Tu subsequent to one unit period Tu, the controller 6 sets the value of the printing signal SI[m] to (0, 0) during the one unit period Tu so as to stop supply of the drive signal Vin[m] to the discharger D[m] (refer to FIG. 20).

When the discharger D is not the target of the discharge state determination process in one unit period Tu and also in the unit period Tu subsequent to the one unit period Tu, the controller 6 sets the value of the printing signal SI[m] to (0, 1) during the one unit period Tu so as to supply the drive signal Vin[m] including the waveform PB to the discharger D[m] (refer to FIG. 20).

### 4. 4. Connector and Residual Vibration Detector

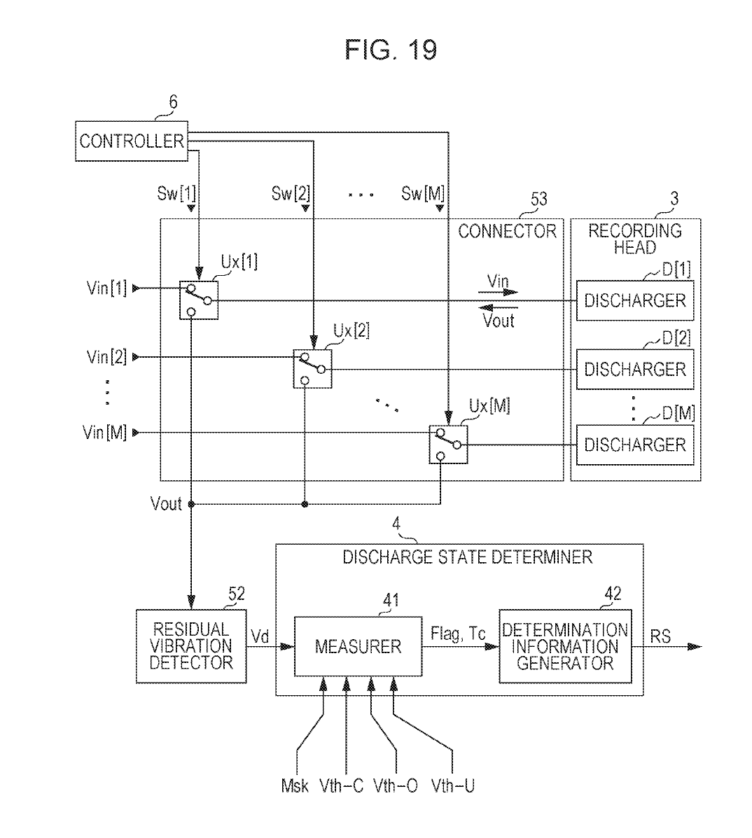

FIG. 19 is a block diagram illustrating an example of a configuration of the connector 53 and the discharge state determiner 4 and illustrating an example of a connection relationship between the recording head 3, the connector 53, the residual vibration detector 52, and the discharge state determiner 4.

As illustrated in FIG. 19, the connector 53 includes M connector circuits Ux of a first stage to an M-th stage (Ux[1], Ux[2], . . . , Ux[M]) that correspond one-to-one to the M dischargers D. The m-th stage connector circuit Ux[m] electrically connects the upper electrode 302 of the piezoelectric element 300 of the discharger D[m] to one of the m-th stage output terminal OTN included in the drive signal generator 51 and the residual vibration detector 52.

Hereinafter, a state where the connector circuit Ux[m] electrically connects the discharger D[m] and the m-th stage output terminal OTN of the drive signal generator 51 will be referred to as a first connection state. In addition, a state where the connector circuit Ux[m] electrically connects the discharger D[m] to the residual vibration detector 52 will be referred to as a second connection state.

The controller 6 outputs the connection control signal Sw that controls the connection state of each connector circuit Ux to each connector circuit Ux.

Specifically, the controller 6 supplies the connection control signal Sw[m] that causes the connector circuit Ux[m] to maintain the first connection state through the entire unit printing period Tu-P to the connector circuit Ux[m] during the unit printing period Tu-P. Thus, the drive signal Vin[m] is supplied from the drive signal generator 51 to the discharger D[m] through the entire unit printing period Tu-P.

When the discharger D[m] is the target of the discharge state determination process in the unit determination period Tu-T, the controller 6 supplies, to the connector circuit Ux[m], the connection control signal Sw[m] that causes the connector circuit Ux[m] to fall into the first connection state during the period of the unit determination period Tu-T excluding the detection period Td and to fall into the second connection state during the detection period Td. Thus, when the discharger D[m] is the target of the discharge state determination process in the unit determination period Tu-T, the drive signal Vin[m] is supplied from the drive signal generator 51 to the discharger D[m] during the period of the unit determination period Tu-T excluding the detection period Td, and the residual vibration signal Vout is supplied from the discharger D[m] to the residual vibration detector 52 during the detection period Td of the unit determination period Tu-T.

When the discharger D[m] is not the target of the discharge state determination process in the unit determination period Tu-T, the controller 6 supplies the connection control signal Sw[m] that causes the connector circuit Ux[m] to maintain the first connection state through the entire unit determination period Tu-T to the connector circuit Ux[m].

The present embodiment assumes that the ink jet printer 1 includes only one residual vibration detector 52 for the M dischargers D as illustrated in FIG. 19 and that the residual vibration detector 52 can detect only the residual vibration occurring in one discharger D during one unit period Tu. That is, the controller 6 according to the present embodiment controls each unit of the ink jet printer 1 such that one of the M dischargers D is selected as the target of the discharge state determination process and that the state of ink discharged is determined in the selected discharger D during one unit determination period Tu-T.

Thus, the controller 6 generates the connection control signal Sw during each unit determination period Tu-T so as to electrically connect the discharger D that is selected as the target of the discharge state determination process to the residual vibration detector 52 in the second connection state during the detection period Td of the unit determination period Tu-T.

The residual vibration detector 52 illustrated in FIG. 19 generates the shaped waveform signal Vd on the basis of the residual vibration signal Vout as described above. The shaped waveform signal Vd is a signal that results from removing a noise component from the residual vibration signal Vout and, furthermore, adjusting the amplitude of the residual vibration signal Vout from which a noise component is removed to an amplitude appropriate for processing performed in the discharge state determiner 4.

The residual vibration detector 52 includes a configuration that can restrict the frequency range of the residual vibration signal Vout to output the shaped waveform signal Vd from which a noise component is removed, such as a high-pass filter or a low-pass filter. The residual vibration detector 52 may be configured to include a negative feedback amplifier that adjusts the amplitude of the residual vibration signal Vout, a voltage follower that outputs the shaped waveform signal Vd having a low impedance by converting the impedance of the residual vibration signal Vout, and the like.

### 4. 5. Selection of Target Discharger for Discharge State Determination Process

As described above, the controller 6 selects one discharger D that is the target of the discharge state determination process in each unit determination period Tu-T. Hereinafter, a relationship between the discharger D that is the target of the discharge state determination process and the waveform of the drive signal Vin supplied to each discharger D will be described with reference to FIG. 20.

FIG. 20 is a timing chart illustrating the waveform of the drive signal Vin that is supplied to each of the plurality of dischargers D during a plurality of unit determination periods Tu-T. Specifically, FIG. 20 illustrates the waveforms of four drive signals Vin[m−1] to Vin[m+2] that are supplied to four dischargers D[m−1] to D[m+2] during a plurality of unit determination periods Tu-T of unit periods Tu1 to Tu5. In the example illustrated in FIG. 20, the four dischargers D[m−1] to D[m+2] are four dischargers D that correspond to four nozzles N belonging to one nozzle array Ln.

The example illustrated in FIG. 20 assumes that the discharger D[m] is the target of the discharge state determination process in the unit period Tu3. Specifically, the controller 6 sets the value of the printing signal SI[m] that specifies operation of the discharger D[m] in the unit period Tu3 to (1, 1) in the example illustrated in FIG. 20. Accordingly, the discharger D[m] is supplied with the drive signal Vin[m] that includes the waveform PT during the unit period Tu3. Then, the waveform PT causes residual vibration in the discharger D[m] during the unit period Tu3, and the state of ink discharged in the discharger D[m] is determined on the basis of the residual vibration.

As described above, when the discharger D[m] is the target of the discharge state determination process in one unit period Tu, the controller 6 controls operation of the drive signal generator 51 to stop supply of the drive signal Vin[m] to the discharger D[m] during the unit period Tu that precedes the one unit period Tu.

That is, as illustrated in the part of FIG. 20 designated by a reference sign γ1, the controller 6 controls operation of the drive signal generator 51 to stop supply of the drive signal Vin[m] to the discharger D[m] during the unit period Tu2 that precedes the unit period Tu3 in which the discharger D[m] is the target of the discharge state determination process. More specifically, the controller 6 sets the value of the printing signal SI[m] that specifies operation of the discharger D[m] in the unit period Tu2 to (0, 0).

Accordingly, it is possible to reduce the magnitude of vibration that occurs at the start of one unit period Tu (the unit period Tu3 in this example) in the discharger D[m] to a smaller extent in comparison with a case where the discharger D[m] is driven during the unit period Tu (the unit period Tu2 in this example) that precedes the one unit period Tu. In other words, it is possible to prevent vibration that occurs in the discharger D[m] before one unit period Tu from being superimposed on the residual vibration that is caused in the discharger D[m] by the waveform PT included in the drive signal Vin[m] which is supplied during the one unit period Tu. Thus, the residual vibration that is caused in the discharger D[m] by the waveform PT can be accurately detected.

As described above, when the discharger D[m] is the target of the discharge state determination process in one unit period Tu, the controller 6 controls operation of the drive signal generator 51 to stop supply of the drive signal Vin[m+1] during the one unit period Tu to the discharger D, for example, the discharger D[m+1], that is adjacent to the discharger D[m] through a partition and that is not the target of the discharge state determination process in the unit period Tu preceding the one unit period Tu.

That is, as illustrated in the part of FIG. 20 designated by a reference sign γ2, the controller 6 controls operation of the drive signal generator 51 to stop supply of the drive signal Vin[m+1] to the discharger D[m+1] that is adjacent to the discharger D[m] during the unit period Tu3 in which the discharger D[m] is the target of the discharge state determination process. More specifically, the controller 6 sets the value of the printing signal SI [m+1] that specifies operation of the discharger D[m+1] in the unit period Tu3 to (0, 0).

Accordingly, it is possible to reduce the magnitude of vibration that propagates from the discharger D[m+1] to the discharger D[m] to a smaller extent in comparison with a case where the discharger D[m+1] is driven during the one unit period Tu (the unit period Tu3 in this example). In other words, it is possible to prevent vibration propagating from the discharger D[m+1] from being superimposed on the residual vibration that is caused in the discharger D[m] by the waveform PT included in the drive signal Vin[m] which is supplied during the one unit period Tu. Thus, the residual vibration that is caused in the discharger D[m] by the waveform PT can be accurately detected.

As illustrated in FIG. 20, the discharger D[m] to which supply of the drive signal Vin[m] is stopped during the unit period Tu preceding the one unit period Tu is set as the target of the discharge state determination process in the one unit period Tu, and the discharger D[m+1] to which supply of the drive signal Vin[m+1] is stopped during the one unit period Tu is set as the target of the discharge state determination process in the unit period Tu subsequent to the one unit period Tu. That is, the controller 6, when selecting one discharger D from the plurality of dischargers D corresponding to the plurality of nozzles N belonging to one nozzle array Ln as the target of the discharge state determination process in one unit period Tu, selects the discharger D that is adjacent to the one discharger D through a partition as the target of the discharge state determination process in the unit period Tu subsequent to the one unit period Tu. Specifically, the controller 6, for example, may select the target of the discharge state determination process for each unit period Tu in order from one end discharger D to the other end discharger D of the plurality of dischargers D corresponding to the plurality of nozzles N belonging to one nozzle array Ln and may stop supply of the drive signal Vin for each unit period Tu in order from the one end discharger D to the other end discharger D at a timing that precedes the selection by one unit period Tu.

As described above, the controller 6 controls operation of the drive signal generator 51 to generate micro vibration in the discharger D that is neither the target of the discharge state determination process nor the target of stopping supply of the drive signal Vin in the unit determination period Tu-T by supplying the drive signal Vin including the waveform PB to the discharger D. Targets of supplying the drive signal Vin that includes the waveform PB include the discharger D, for example, the discharger D[m−1], that is adjacent to the discharger D[m], which is the target of the discharge state determination process in the one unit period Tu, through a partition and that is the target of the discharge state determination process in the unit period Tu preceding the one unit period Tu.

That is, as illustrated in the part of FIG. 20 designated by a reference sign γ3, the controller 6 controls operation of the drive signal generator 51 to supply the drive signal Vin[m−1] including the waveform PB to the discharger D[m−1] that is adjacent to the discharger D[m] during the unit period Tu3 in which the discharger D[m] is the target of the discharge state determination process. More specifically, the controller 6 sets the value of the printing signal SI[m−1] that specifies operation of the discharger D[m−1] in the unit period Tu3 to (0, 1).

It is a concern that vibration propagates from the discharger D[m−1] to the discharger D[m], which is adjacent to the discharger D[m−1] through a partition, when the discharger D[m−1] is driven during the one unit period Tu and that the residual vibration occurring in the discharger D[m] during the one unit period Tu may not be accurately detected.

However, as illustrated in FIG. 17, the detection period Td that is a period of detecting residual vibration temporally precedes the start of the waveform PB in each unit period Tu. Thus, even if the vibration of the discharger D[m−1] caused by the waveform PB propagates to the discharger D[m], this does not impede detection of the residual vibration occurring in the discharger D[m].

In addition, as in the present embodiment, micro vibration occurs only in the dischargers D except for the discharger D that is the target of the discharge state determination process in the one unit period Tu and for the discharger D that is the target of the discharge state determination process in the unit period Tu subsequent to the one unit period Tu, by supplying the drive signal Vin including the waveform PB to the dischargers D during the one unit period Tu. Thus, thickening of ink in the cavity 320 of the discharger D can be effectively suppressed.

### 4. 6. Discharge State Determiner

The discharge state determiner 4 illustrated in FIG. 19 determines the state of ink discharged in the discharger D on the basis of the shaped waveform signal Vd output by the residual vibration detector 52 and generates the determination information RS that indicates the result of the determination.

The discharge state determiner 4 includes a measurer 41 and a determination information generator 42 as illustrated in FIG. 19. The measurer 41 measures the temporal length of one cycle of the residual vibration occurring in the discharger D on the basis of the shaped waveform signal Vd output by the residual vibration detector 52 and generates a measurement signal Tc that indicates the result of the measurement. In addition, the measurer 41 generates a validity flag Flag that indicates whether the measurement signal Tc generated has a valid value. The determination information generator 42 outputs the determination information RS indicating the result of determining the state of ink discharged in the discharger D on the basis of the measurement signal Tc and the validity flag Flag output by the measurer 41.

As illustrated in FIG. 19, the measurer 41 is supplied with the shaped waveform signal Vd that is output by the residual vibration detector 52, a mask signal Msk that is generated by the controller 6, a threshold potential Vth-C that is set to the central potential level of the amplitude of the shaped waveform signal Vd, a threshold potential Vth-O that is set to a higher potential than the threshold potential Vth-C, and a threshold potential Vth-U that is set to a lower potential than the threshold potential Vth-C.

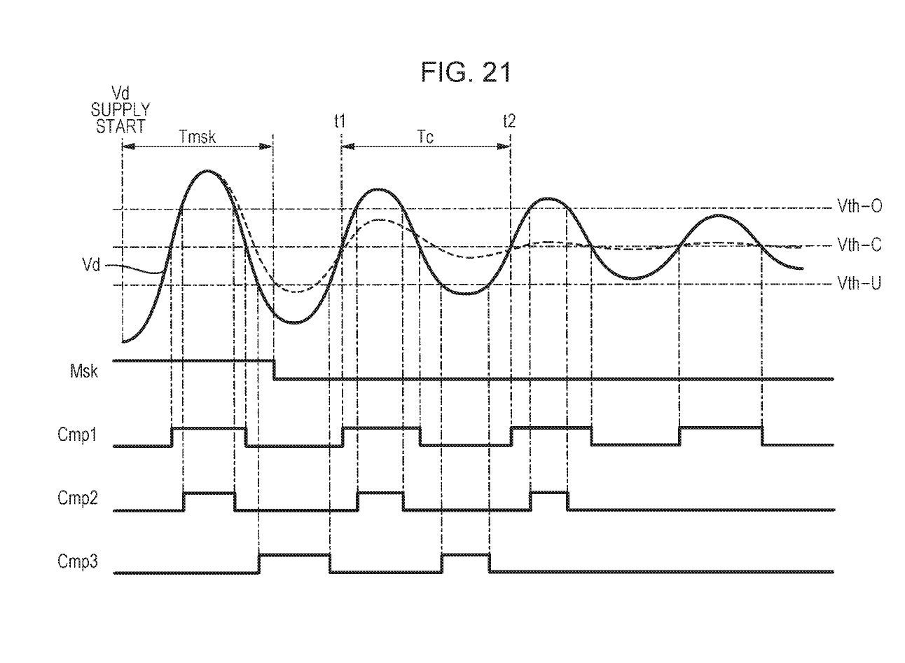

FIG. 21 is a timing chart illustrating operation of the measurer 41.

As illustrated in FIG. 21, the measurer 41 compares the potential of the shaped waveform signal Vd with the threshold potential Vth-C and generates a comparison signal Cmp1 of which the level is high when the potential of the shaped waveform signal Vd is greater than or equal to the threshold potential Vth-C and is low when the potential of the shaped waveform signal Vd is less than the threshold potential Vth-C. In addition, the measurer 41 compares the potential of the shaped waveform signal Vd with the threshold potential Vth-O and generates a comparison signal Cmp2 of which the level is high when the potential of the shaped waveform signal Vd is greater than or equal to the threshold potential Vth-O and is low when the potential of the shaped waveform signal Vd is less than the threshold potential Vth-O. In addition, the measurer 41 compares the potential of the shaped waveform signal Vd with the threshold potential Vth-U and generates a comparison signal Cmp3 of which the level is high when the potential of the shaped waveform signal Vd is less than the threshold potential Vth-U and is low when the potential of the shaped waveform signal Vd is greater than or equal to the threshold potential Vth-U.

The mask signal Msk is a signal of which the level is high for only a predetermined period Tmsk from the start of supply of the shaped waveform signal Vd from the residual vibration detector 52. In the present embodiment, by generating the measurement signal Tc from the shaped waveform signal Vd only after the period Tmsk elapses, it is possible to obtain the highly accurate measurement signal Tc from which a noise component that is superimposed immediately after the start of the residual vibration is removed.

The measurer 41 includes a counter (not illustrated). The counter starts to count a clock signal (not illustrated) at a time t1 that is the timing at which the potential of the shaped waveform signal Vd becomes equal to the threshold potential Vth-C for the first time after the mask signal Msk falls to a low level. The counter ends the counting of the clock signal at a time t2 that is the timing at which the potential of the shaped waveform signal Vd becomes equal to the threshold potential Vth-C for the second time after the counting is started and outputs the obtained count value as the measurement signal Tc. As such, the measurer 41 generates the measurement signal Tc by measuring the temporal length from the time t1 to the time t2 as the temporal length of one cycle of the shaped waveform signal Vd.

The possibility that the measurement signal Tc cannot be accurately measured increases when the amplitude of the shaped waveform signal Vd is small as illustrated by a broken line in FIG. 21. In addition, when the amplitude of the shaped waveform signal Vd is small, there exists the possibility of an abnormal discharge in actuality even if the state of discharge in the discharger D is determined to be normal on the basis of only the result of the measurement signal Tc. For example, the amplitude of the shaped waveform signal Vd being small is considered to be a state where ink cannot be discharged because ink is not poured into the cavity 320.

Therefore, the present embodiment determines whether the amplitude of the shaped waveform signal Vd is sufficiently large enough to measure the measurement signal Tc and outputs the result of the determination as the validity flag Flag. Specifically, the measurer 41 sets the value of the validity flag Flag to the value “1” to indicate that the measurement signal Tc is valid when the potential of the shaped waveform signal Vd exceeds the threshold potential Vth-O and falls below the threshold potential Vth-U during a period in which the counter performs counting, that is, during the period from the time t1 to the time t2 or otherwise sets the value of the validity flag Flag to the value “0” and then outputs the validity flag Flag.

As such, the measurer 41 according to the present embodiment generates the validity flag Flag indicating whether the amplitude of the shaped waveform signal Vd is sufficiently large enough to measure the measurement signal Tc in addition to generating the measurement signal Tc indicating the temporal length of one cycle of the shaped waveform signal Vd. Thus, the state of ink discharged in the discharger D can be accurately determined.

The determination information generator 42 illustrated in FIG. 19 determines the state of ink discharged in the discharger D on the basis of the measurement signal Tc and the validity flag Flag output by the measurer 41 and generates the determination information RS that indicates the result of the determination.

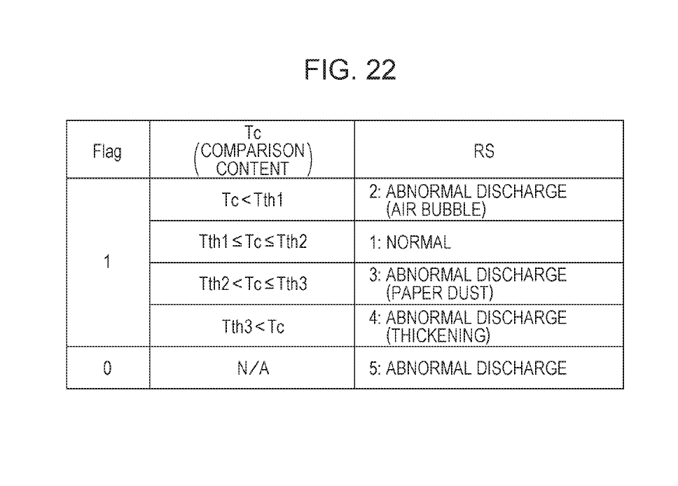

FIG. 22 is a descriptive diagram illustrating the content of determination performed by the determination information generator 42.

As illustrated in FIG. 22, the determination information generator 42 compares the temporal length of the measurement signal Tc with three thresholds of a threshold Tth1, a threshold Tth2, and a threshold Tth3 or with a part of these three thresholds.

The threshold Tth1 is a value that indicates a boundary between the temporal lengths of one cycle of the residual vibration: the temporal length of one cycle of the residual vibration in a case where the frequency of the residual vibration is increased by generation of an air bubble in the cavity 320 and the temporal length of one cycle of the residual vibration in a case where the state of discharge is normal.

The threshold Tth2 is a threshold representing a longer temporal length than the threshold Tth1 and is a value that indicates a boundary between the temporal lengths of one cycle of the residual vibration: the temporal length of one cycle of the residual vibration in a case where the frequency of the residual vibration is decreased by attachment of a foreign object such as paper dust near the outlet of the nozzle N and the temporal length of one cycle of the residual vibration in a case where the state of discharge is normal.

The threshold Tth3 is a threshold representing a longer temporal length than the threshold Tth2 and is a value that indicates a boundary between the temporal lengths of one cycle of the residual vibration: the temporal length of one cycle of the residual vibration in a case where the frequency of the residual vibration is decreased from that in a case of attachment of a foreign object such as paper dust by thickening or solidification of ink near the nozzle N and the temporal length of one cycle of the residual vibration in a case where a foreign object such as paper dust is attached near the outlet of the nozzle N.

As illustrated in FIG. 22, the determination information generator 42 determines that the state of ink discharged in the discharger D is normal when the value of the validity flag Flag is “1” with the measurement signal Tc satisfying “Tth1≦Tc≦Tth2” and sets the determination information RS to the value “1” that indicates the state of discharge being normal.

The determination information generator 42 determines that an abnormal discharge occurs because of an air bubble generated in the cavity 320 when the value of the validity flag Flag is “1” with the measurement signal Tc satisfying “Tc<Tth1” and sets the determination information RS to the value “2” that indicates an abnormal discharge caused by an air bubble.

The determination information generator 42 determines that an abnormal discharge occurs because of a foreign object such as paper dust attached near the outlet of the nozzle N when the value of the validity flag Flag is “1” with the measurement signal Tc satisfying “Tth2<Tc≦Tth3” and sets the determination information RS to the value that indicates an abnormal discharge caused by attachment of a foreign object such as paper dust.

The determination information generator 42 determines that an abnormal discharge occurs because of thickening of ink in the cavity 320 when the value of the validity flag Flag is “1” with the measurement signal Tc satisfying “Tth3<Tc” and sets the determination information RS to the value “4” that indicates an abnormal discharge caused by thickening of ink.

The determination information generator 42 sets the determination information RS to the value “5” that indicates an abnormal discharge occurring from another cause, such that ink is not poured, when the value of the validity flag Flag is “0”.

As such, the determination information generator 42 determines the state of discharge in the discharger D on the basis of the measurement signal Tc and of the validity flag Flag and generates the determination information RS that indicates the result of the determination.

The controller 6 stores the determination information RS output by the determination information generator 42 in association with the stage number of the discharger D corresponding to the determination information RS in the storage 60. Thus, it is possible to find out which one of the M dischargers D performs an abnormal discharge. Accordingly, the maintenance process can be performed at an appropriate timing by taking into consideration the number of dischargers D performing an abnormal discharge, the position of the discharger D performing an abnormal discharge, and the like. Therefore, it is possible to prevent the quality of an image formed in the printing process from being degraded by an abnormal discharge D occurring in the discharger D.

### 5. Conclusion of Embodiment

As described thus far, supply of the drive signal Vin[m] to the discharger D[m] is stopped during the unit period Tu preceding the one unit period Tu in the present embodiment when the state of ink discharged in the discharger D[m] is determined on the basis of the residual vibration that occurs in the discharger D[m] during the one unit period Tu. Thus, the magnitude of vibration that occurs in the discharger D[m] at the start of the one unit period Tu can be reduced to a smaller extent, and the residual vibration that occurs in the discharger D[m] during the one unit period Tu can be accurately detected.

Supply of the drive signal Vin[m+1] to the discharger D[m+1] that is adjacent to the discharger D[m] through a partition is stopped during the one unit period Tu in the present embodiment when the state of ink discharged in the discharger D[m] is determined on the basis of the residual vibration that occurs in the discharger D[m] during the one unit period Tu. Thus, the magnitude of vibration that propagates from the discharger D[m+1] to the discharger D[m] can be reduced to a smaller extent during the one unit period Tu, and the residual vibration that occurs in the discharger D[m] during the one unit period Tu can be accurately detected.

The dischargers D except for the discharger D that is the target of the discharge state determination process in the one unit period Tu and for the discharger D that is the target of the discharge state determination process in the unit period Tu subsequent to the one unit period Tu are driven such that micro vibration occurs therein during the one unit period Tu in the present embodiment. Thus, it is possible to reduce the possibility of an abnormal discharge caused by thickening of ink.

Furthermore, the waveform PT that is used to generate and detect residual vibration is arranged to temporally precede the waveform PB that generates micro vibration in each unit period Tu in the present embodiment. Thus, even if the discharger D[m−1] is driven by the drive signal Vin including the waveform PB, residual vibration that occurs in the discharger D[m] can be accurately detected.

The discharger D[m] that is the target of the discharge state determination process in the one unit period Tu in the present embodiment is an example of “first discharger”. The piezoelectric element 300, the cavity 320, and the nozzle N included in the first discharger are an example of “first piezoelectric element”, “first pressure chamber”, and “first nozzle”. The drive signal Vin[m] that is supplied to the discharger D[m] is an example of “first drive signal”, and the switch TX[m] that outputs the drive signal Vin[m] is an example of “first switch”.

The discharger D[m+1] that is adjacent to the discharger D[m], which is an example of the first discharger, through a partition is an example of “second discharger”. The piezoelectric element 300, the cavity 320, and the nozzle N included in the second discharger are an example of “second piezoelectric element”, “second pressure chamber”, and “second nozzle”. The drive signal Vin[m+1] that is supplied to the discharger D[m+1] is an example of “second drive signal”, and the switch TX[m+1] that outputs the drive signal Vin[m+1] is an example of “second switch”.

### B. Modification Example

Various modifications may be carried out to the embodiment described above. Specific forms of modification will be described below. Two or more forms that are arbitrarily selected from the description below may be appropriately combined to the extent not inconsistent with each other.

Elements of the modification examples described below having an effect or a function equivalent to the embodiment will be designated by the reference sign that is referenced in the above description, and a detailed description of each thereof will be appropriately omitted.

### Modification Example 1

Supply of the drive signal Vin[m] to the discharger D[m] is stopped during the unit period Tu preceding the one unit period Tu in the above embodiment to maintain the voltage applied to the piezoelectric element 300 at a constant level when the discharger D[m] is the target of the discharge state determination process in the one unit period Tu. However, the invention is not limited to such a form. The voltage applied to the piezoelectric element 300 may be maintained at a constant level by supplying the drive signal Vin[m] having a constant potential level to the discharger D[m]. For example, the drive signal Vin[m] of which the potential is set to the reference potential V0 may be supplied to the discharger D[m] to maintain the voltage applied to the piezoelectric element 300 at a constant level.

### Modification Example 2

The discharge state determination process is performed during the unit determination period Tu-T in the embodiment and in the modification example described above. However, the invention is not limited to such a form. The discharge state determination process may be performed during the unit printing period Tu-P. That is, the printing process and the discharge state determination process may be performed during one unit period Tu.

For example, the waveform PA1 included in the printing drive waveform signal Com-AP may be used to detect residual vibration (used as the waveform PT) during the unit printing period Tu-P illustrated in FIG. 16. In this case, residual vibration that occurs in the discharger D driven by the waveform PA1 may be detected by using a part of a period during which the potential of the waveform PA1 is maintained at the maximum potential Va12 as the detection period Td.

The waveform that detects residual vibration may be a waveform such as the waveform PA1 or the waveform PA2 that discharges ink or may be a waveform such as the waveform PB that does not discharge ink.

### Modification Example 3

The ink jet printer 1 according to the embodiment and the modification examples described above includes one residual vibration detector 52 and one discharge state determiner 4 and performs the discharge state determination process on one discharger D during one unit period Tu. However, the invention is not limited to such a form. The ink jet printer 1 may have a configuration that can perform the discharge state determination process on two or more dischargers D during one unit period Tu.

For example, the ink jet printer 1 may have a configuration that includes a plurality of residual vibration detectors 52 so that the residual vibration signals Vout from the plurality of dischargers D can be detected at the same time during each unit period Tu. In this case, the discharge state determiner 4 is preferably configured to be capable of determining the state of ink discharged in the plurality of dischargers D on the basis of a plurality of shaped waveform signals Vd output by the plurality of residual vibration detectors 52. For example, the discharge state determiner 4 may include a plurality of measurers 41 and a plurality of determination information generators 42 in correspondence with the plurality of residual vibration detectors 52.

### Modification Example 4

The ink jet printer 1 according to the embodiment and the modification examples described above is a line printer in which the nozzle array Ln is disposed such that the range YNL includes the range YP. However, the invention is not limited to such a form. The ink jet printer 1 may be a serial printer in which the recording head 3 performs the printing process by reciprocating in the Y-axis direction.

### Modification Example 5

The ink jet printer 1 according to the embodiment and the modification examples described above can discharge four CMYK color inks. However, the invention is not limited to such a form. The ink jet printer 1 may be capable of discharging at least one or more color inks, and the color of ink may be a color other than CMYK.

In addition, while the ink jet printer 1 according to the embodiment and the modification examples described above includes four nozzle arrays Ln, the ink jet printer 1 may include at least one or more nozzle arrays Ln. For example, when the ink jet printer 1 includes one nozzle array Ln, the ink jet printer 1 may include at least two or more dischargers D (that is, M may be a natural number satisfying M≧2).

### Modification Example 6

The drive waveform signal Com includes two signals of the drive waveform signals Com-A and Com-B in the embodiment and in the modification examples described above. However, the invention is not limited to such a form. The drive waveform signal Com may include one or more signals. That is, the drive waveform signal Com may be one signal, for example, a signal that includes only the drive waveform signal Com-A or may be three or more signals, for example, a signal that includes drive waveform signals Com-A, Com-B, and Com-C.

In addition, while the unit period Tu includes two control periods Ts1 and Ts2 in the embodiment and in the modification examples described above, the invention is not limited to such a form. The unit period Tu may be configured of one control period Ts or may include three or more control periods Ts.

In addition, while the printing signal SI[m] is a two-bit signal in the embodiment and in the modification examples described above, the number of bits of the printing signal SI[m] may be appropriately determined according to the number of shades to be displayed, the number of control periods Ts included in the unit period Tu, the number of signals included in the drive waveform signal Com, and the like.

### Modification Example 7

The head driver 5 includes one drive signal generator 51 that is supplied with one type of drive waveform signal Com in the embodiment and in the modification examples described above. However, the invention is not limited to such a form. The head driver 5, for example, may include a plurality of drive signal generators 51 that is disposed for each color ink discharged by the discharger D, and the controller 6 may supply a plurality of types of drive waveform signal Com that corresponds one-to-one to the plurality of drive signal generators 51 to the head driver 5.

What is claimed is:

1. A liquid discharging apparatus comprising:
a waveform signal generator that generates a drive waveform signal which includes a plurality of waveforms including an inspection waveform;
a first discharger including
a first piezoelectric element that is displaced by being supplied with a first drive signal which includes a waveform selected from the plurality of waveforms included in the drive waveform signal,
a first pressure chamber that has internal pressure increased or decreased by the displacement of the first piezoelectric element, and
a first nozzle that communicates with the first pressure chamber and is capable of discharging liquid filling the first pressure chamber in response to an increase or a decrease in the internal pressure of the first pressure chamber;
a first switch that is capable of switching whether to supply the first drive signal to the first piezoelectric element for each unit period; and
a detector that detects residual vibration occurring in the first discharger after the first drive signal including the inspection waveform is supplied to the first piezoelectric element,
wherein the first switch stops supply of the first drive signal to the first piezoelectric element during a unit period that precedes one unit period when the first drive signal including the inspection waveform is supplied to the first piezoelectric element during the one unit period.

2. The liquid discharging apparatus according to claim 1, further comprising:
a second discharger including
a second piezoelectric element that is displaced by being supplied with a second drive signal which includes a waveform selected from the plurality of waveforms included in the drive waveform signal,
a second pressure chamber that is adjacent to the first pressure chamber through a partition and has internal pressure increased or decreased by the displacement of the second piezoelectric element, and
a second nozzle that communicates with the second pressure chamber and is capable of discharging liquid filling the second pressure chamber in response to an increase or a decrease in the internal pressure of the second pressure chamber; and
a second switch that is capable of switching whether to supply the second drive signal to the second piezoelectric element for each unit period,
wherein the second switch stops supply of the second drive signal to the second piezoelectric element during the one unit period.

3. The liquid discharging apparatus according to claim 2,
wherein the second switch supplies the second drive signal including the inspection waveform to the second piezoelectric element during a unit period subsequent to the one unit period, and
the detector detects residual vibration occurring in the second discharger after the second drive signal including the inspection waveform is supplied to the second piezoelectric element.

4. The liquid discharging apparatus according to claim 1,
wherein the plurality of waveforms included in the drive waveform signal includes a micro vibration waveform that displaces the first piezoelectric element such that the liquid is not discharged from the first nozzle when the drive waveform signal is supplied to the first piezoelectric element, and
the micro vibration waveform is started after the end of the inspection waveform in the unit period.

5. The liquid discharging apparatus according to claim 1,
wherein the plurality of waveforms included in the drive waveform signal includes a micro vibration waveform that displaces the first piezoelectric element such that the liquid is not discharged from the first nozzle when the drive waveform signal is supplied to the first piezoelectric element, and
the first switch supplies the first drive signal including the micro vibration waveform to the first piezoelectric element during a unit period subsequent to the one unit period.

6. The liquid discharging apparatus according to claim 1,
wherein the first switch switches whether to supply the first drive signal to the first piezoelectric element for each unit period on the basis of a specification signal that specifies a waveform to be supplied to the first piezoelectric element for each unit period from the plurality of waveforms included in the drive waveform signal.

7. A head unit that is supplied with a drive waveform signal which includes a plurality of waveforms including an inspection waveform, the unit comprising:
a first discharger including
a first piezoelectric element that is displaced by being supplied with a first drive signal which includes a waveform selected from the plurality of waveforms included in the drive waveform signal,
a first pressure chamber that has internal pressure increased or decreased by the displacement of the first piezoelectric element, and
a first nozzle that communicates with the first pressure chamber and is capable of discharging liquid filling the first pressure chamber in response to an increase or a decrease in the internal pressure of the first pressure chamber;
a first switch that is capable of switching whether to supply the first drive signal to the first piezoelectric element for each unit period; and
a detector that detects residual vibration occurring in the first discharger after the first drive signal including the inspection waveform is supplied to the first piezoelectric element,
wherein the first switch stops supply of the first drive signal to the first piezoelectric element during a unit period that precedes one unit period when the first drive signal including the inspection waveform is supplied to the first piezoelectric element during the one unit period.

8. A control method for a liquid discharging apparatus including
a waveform signal generator that generates a drive waveform signal which includes a plurality of waveforms including an inspection waveform,
a first discharger including a first piezoelectric element that is displaced by being supplied with a first drive signal which includes a waveform selected from the plurality of waveforms included in the drive waveform signal, a first pressure chamber that has internal pressure increased or decreased by the displacement of the first piezoelectric element, and a first nozzle that communicates with the first pressure chamber and is capable of discharging liquid filling the first pressure chamber in response to an increase or a decrease in the internal pressure of the first pressure chamber,
a first switch that is capable of switching whether to supply the first drive signal to the first piezoelectric element for each unit period, and
a detector that detects residual vibration occurring in the first discharger after the first drive signal including the inspection waveform is supplied to the first piezoelectric element,
the method comprising:
controlling operation of the first switch to stop supply of the first drive signal to the first piezoelectric element during a unit period that precedes one unit period when the first drive signal including the inspection waveform is supplied to the first piezoelectric element during the one unit period.

9. A control program for a liquid discharging apparatus including
a waveform signal generator that generates a drive waveform signal which includes a plurality of waveforms including an inspection waveform,
a first discharger including a first piezoelectric element that is displaced by being supplied with a first drive signal which includes a waveform selected from the plurality of waveforms included in the drive waveform signal, a first pressure chamber that has internal pressure increased or decreased by the displacement of the first piezoelectric element, and a first nozzle that communicates with the first pressure chamber and is capable of discharging liquid filling the first pressure chamber in response to an increase or a decrease in the internal pressure of the first pressure chamber,
a first switch that is capable of switching whether to supply the first drive signal to the first piezoelectric element for each unit period,
a detector that detects residual vibration occurring in the first discharger after the first drive signal including the inspection waveform is supplied to the first piezoelectric element, and
a computer,
the program causing the computer to function as a controller that controls operation of the first switch to stop supply of the first drive signal to the first piezoelectric element during a unit period that precedes one unit period when the first drive signal including the inspection waveform is supplied to the first piezoelectric element during the one unit period.
